(19) United States
(12) Patent Application Publication
(10) Pub. No.: US 2026/0179104 A1
(43) Pub. Date: Jun. 25, 2026

(54) MANAGEMENT SYSTEM, MANAGEMENT METHOD, AND STORAGE MEDIUM

(71) Applicant: NEC Corporation, Minato-ku, Tokyo (JP)

(72) Inventors: Megumi ETO, Tokyo (JP); Yuuki TANAKA, Tokyo (JP); Rika KONNO, Tokyo (JP); Ruriko YAMADA, Tokyo (JP); Akira FUKATA, Tokyo (JP); Akiyoshi TASHIRO, Tokyo (JP); Shuichi IGARASHI, Tokyo (JP)

(73) Assignee: NEC Corporation, Minato-ku, Tokyo (JP)

(21) Appl. No.: 19/128,597

(22) PCT Filed: Nov. 20, 2023
(86) PCT No.: PCT/JP2023/041575

§ 371 Date: May 9, 2025

(30) Foreign Application Priority Data
Nov. 29, 2022 (JP) 2022-190457

(51) Int. Cl. G06Q 30/018

(52) U.S. Cl. CPC G06Q 30/018

(57) ABSTRACT

A management system according to an aspect of the present disclosure includus: at least one memory storing a set of instructions; and at least one processor configured to execute the set of instructions to: receive summary information about an absorption source of carbon dioxide; calculate, from the summary information, an approximate amount of money of revenue resulting from a sale of a carbon credit of the absorption source; and present the calculated approximate amount of money of revenue.

### TECHNICAL FIELD

The present disclosure relates to a management technique.

### BACKGROUND ART

In recent years, reduction of the emission amount of the greenhouse gas such as carbon dioxide is an important issue. Offsetting the emission amount of the greenhouse gas such as carbon dioxide by the absorption amount of carbon dioxide is also regarded as a kind of reduction in the emission amount of the greenhouse gas. Based on such an idea, it has become common to trade the absorption amount of carbon dioxide by forest protection or the like as a credit (hereinafter, also referred to as carbon credit). In a case of creating a credit, the creator or the like generally plans a project for reducing the emission amount of carbon dioxide, creates a description of the project, and applies for registration of the project based on the description. In the following description, a description of a carbon credit project is also referred to as a project description. The description of the carbon credit project is also simply referred to as a description. The examination of the project by the description is performed by a credit authentication organization.

When the description of the project is authenticated by the authentication organization, a credit corresponding to a reduction amount of carbon dioxide emission as an achievement of implementation of the project is issued.

The credit includes a credit for a reduction amount due to avoidance and reduction of carbon dioxide emission, and a credit for a fixed amount due to absorption and storage of carbon dioxide. Examples of the fixation by absorption and storage of carbon dioxide include absorption of carbon dioxide by plants such as forests, grasslands, and cultivated lands. The carbon dioxide absorbed here is fixed as a plant.

PTL 1 discloses an example of a system for managing carbon credits. In the example shown in PTL 1, the system distributes carbon credits to consumers using lots.

### CITATION LIST

### Patent Literature

PTL 1: JP 2011-521314 A

### SUMMARY OF INVENTION

### Technical Problem

In order to create a carbon credit, it is necessary to create a carbon credit project description using various information about the carbon dioxide absorption source (for example, forests, etc.). In order for the right holder of the absorption source to determine whether to create a carbon credit, information about the profit obtained by creating the carbon credit is useful.

However, the amount of money of a carbon credit issued by authenticating the project description depends on the amount of reduction due to absorption of carbon dioxide described in the description. In order to know the amount of money of a carbon credit to be issued, it is necessary to calculate the amount of carbon dioxide reduction by the absorption source. It is necessary to have information about the absorption source used for calculating the reduction amount of carbon dioxide and knowledge about a calculation method using the information.

It is not easy for the owner of the absorption source who is not familiar with the calculation of the absorption amount of carbon dioxide and the calculation of the amount of money of a carbon credit to obtain information about the profit obtained by creating the carbon credit and determine whether to create the carbon credit.

In the technique of PTL 1, although the load of distribution of a carbon credit can be reduced, it is not possible to support determination as to whether to create carbon credits.

An object of the present disclosure is to provide a management system or the like that can support determination as to whether to create a carbon credit.

### SOLUTION TO PROBLEM

A management system according to an aspect of the present disclosure includes a summary information reception means for receiving summary information about an absorption source of carbon dioxide, an approximate calculation means for calculating, from the summary information, an approximate amount of money of revenue resulting from a sale of a carbon credit of the absorption source, and an approximate amount-of-money presentation means for presenting the calculated approximate amount of money of revenue.

A management method according to an aspect of the present disclosure includes receiving summary information of an absorption source of carbon dioxide, calculating, from the summary information, an approximate amount of money of revenue resulting from a sale of a carbon credit of the absorption source, and presenting the approximate amount of the revenue, the approximate amount being approximated.

A program according to an aspect of the present disclosure causes a computer to execute a summary information reception process of receiving summary information about an absorption source of carbon dioxide, an approximate calculation process of calculating, from the summary information, an approximate amount of money of revenue resulting from a sale of a carbon credit of the absorption source, and an approximate amount-of-money presentation process of presenting the calculated approximate amount of money of revenue. An aspect of the present disclosure is also achieved by a storage medium that stores the above-described program.

### Advantageous Effects of Invention

The present disclosure has an effect of supporting determination as to whether to create a carbon credit.

### BRIEF DESCRIPTION OF DRAWINGS

FIG. 1 is a block diagram illustrating an example of a configuration of a management system according to the first example embodiment of the present disclosure.

FIG. 2 is a flowchart illustrating an example of an operation of the management system according to the first example embodiment of the present disclosure.

FIG. 3 is a block diagram illustrating an example of a configuration of the management system according to the second example embodiment of the present disclosure.

FIG. 4 is a diagram schematically illustrating a communication network to which the management system according to the second example embodiment of the present disclosure is connected and a device connected to the communication network.

FIG. 5 is a block diagram illustrating an example of configurations of an application processing unit and an absorption source information processing unit of the management system according to the second example embodiment of the present disclosure.

FIG. 6 is a block diagram illustrating an example of a configuration of an approximate calculation unit of the management system according to the second example embodiment of the present disclosure.

FIG. 7 is a block diagram illustrating an example of a configuration of a generation unit of a management system according to the second example embodiment of the present disclosure.

FIG. 8 is a flowchart illustrating an example of an overall operation of the management system according to the second example embodiment of the present disclosure.

FIG. 9 is a flowchart illustrating an example of an operation of an application process of the management system according to the second example embodiment of the present disclosure.

FIG. 10 is a flowchart illustrating an example of an operation of an approximate calculation process of the management system according to the second example embodiment of the present disclosure.

FIG. 11 is a flowchart illustrating an example of an operation of an absorption source information reception process of the management system according to the second example embodiment of the present disclosure.

FIG. 12 is a flowchart illustrating an example of an operation of a document creation process of the management system according to the second example embodiment of the present disclosure.

FIG. 13 is a flowchart illustrating an example of an operation of an authentication process of the management system according to the second example embodiment of the present disclosure.

FIG. 14 is a flowchart illustrating an example of an operation of a document verification process of the management system according to the second example embodiment of the present disclosure.

FIG. 15 is a flowchart illustrating an example of an operation of a content authentication process of the management system according to the second example embodiment of the present disclosure.

FIG. 16 is a flowchart illustrating an example of an operation of an issuance process of the management system according to the second example embodiment of the present disclosure.

FIG. 17 is a flowchart illustrating an example of an operation of a transaction process of the management system according to the second example embodiment of the present disclosure.

FIG. 18 is a flowchart illustrating an example of an operation of a matching process of the management system according to the second example embodiment of the present disclosure.

FIG. 19 is a diagram illustrating an example of a hardware configuration of a computer that can implement the management system according to the example embodiment of the present disclosure.

### EXAMPLE EMBODIMENT

Hereinafter, example embodiments of the present disclosure will be described in detail using the drawings.

### First Example Embodiment

First, the first example embodiment of the present disclosure will be described in detail with reference to the drawings.

### Configuration

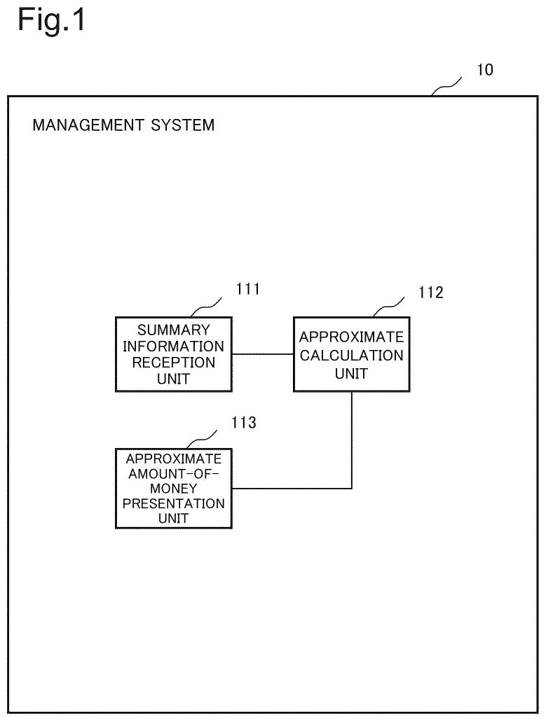

FIG. 1 is a block diagram illustrating an example of a configuration of a management system according to the first example embodiment of the present disclosure. The example illustrated in FIG. 1 includes a summary information reception unit 111, an approximate calculation unit 112, and an approximate amount-of-money presentation unit 113 according to the present example embodiment. The summary information reception unit 111 receives summary information of an absorption source of carbon dioxide. The approximate calculation unit 112 calculates an approximate amount of money of revenue resulting from the sale of the carbon credit of the absorption source from the summary information. The approximate amount-of-money presentation unit 113 presents an approximate amount of the revenue, the approximate amount being approximated. The summary information is less than the absorption source information that is the information about the absorption source used to generate the project description of the carbon credit.

In the description of the present disclosure, an absorption source represents an object that absorbs carbon dioxide, for example, forests, cultivated lands, grasslands, and the like. Hereinafter, a case where the absorption source is a forest will be mainly described. In a case where the absorption source is other than the forest, the following “trees” can be read as “vegetation”. The absorption source may be a facility (for example, an educational facility such as a university, a hotel, a wedding hall, a house with a garden, and the like) in which a region where the plant exists (for example, a garden, a rooftop garden, a wall face on which a plant is present, and the like) exists. The absorption source may be a water area in which organisms such as waterweeds and plankton that absorb carbon dioxide inhabit. The absorption source may be a facility or the like that generates an artificial substance to which carbon dioxide is immobilized.

In the following description, in an absorption source, an object that absorbs carbon dioxide is referred to as an absorber. In a case where the absorption source is a forest, the absorber is, for example, a tree. In a case where the absorption source is a cultivated land, the absorber is, for example, a crop. In a case where the absorption source is a grass field, the absorber is, for example, grass. In a case where the absorption source is a facility in which a plant is planted, the absorber is a planted plant (for example, trees, flowers, and the like). In a case where the absorption source is a water area in which organisms that absorb carbon dioxide inhabit, the absorber is an organism that absorbs carbon dioxide and that inhabits the water area. In a case where the absorption source is a facility or the like that generates an artificial substance to which carbon dioxide is fixed, the absorber is, for example, an artificial substance to which carbon dioxide is fixed.

As described later, the summary information is information about the absorption source. As described above, the absorption amount of carbon dioxide by the absorption source is described in the project description. In order to calculate the absorption amount of carbon dioxide, information about the absorption source (that is, the absorption source information) is used. The summary information is information less than the absorption source information used for calculating the absorption amount of carbon dioxide by the absorption source described in the description of the project. The absorption source information is information about the absorption source including information necessary for generating a description of a project. The absorption source information will be described in detail later. The summary information being less than the absorption source information will be described in detail later.

The absorption source information is information about the absorption source including information necessary for generating a description of a project. The absorption source information includes, for example, information for calculating an absorption amount (that is, the absorption amount of carbon dioxide having accuracy based on the description of the project description) of carbon dioxide described in a project description. The information about the absorption source necessary for generating the project description includes information about the absorption source and a substance that absorbs carbon dioxide (that is, the absorber described above) for calculating the absorption amount of carbon dioxide based on the specification of the project description (in other words, it is described with the accuracy required by the organization that authenticates the description of the project). In this case, for example, in a case where the absorption source is a forest and the absorption material is a tree, the information about the absorption source and the absorber is, for example, an accurate area of the absorption source, detailed information about trees present in the absorption source, an absorption amount of carbon dioxide absorbed by trees, and the like based on the specification of the description of the project. A specific example of the absorption source information will be described in detail later. The project description is a document in which predetermined information is described in a predetermined format. The project description is also referred to as a project description in the present disclosure.

The summary information is information for simply calculating the approximate amount of money of a carbon credit (for example, information for simply calculating an approximate absorption amount of carbon dioxide necessary for calculating an approximate amount of money of a carbon credit). This approximate absorption amount is an absorption amount of carbon dioxide with accuracy less than the accuracy of the absorption amount of carbon dioxide described in the description of the project.

The approximate amount of money of revenue resulting from the sale of the carbon credit of the absorption source may be, for example, an estimated value of the amount of money of a carbon credit calculated from an estimated value of the absorption amount of carbon dioxide by the absorption source estimated from the summary information. The approximate amount of money of revenue resulting from the sale of the carbon credit of the absorption source may be, for example, an estimated amount of money that the right holder of the absorption source can obtain by the sale of the carbon credit. The estimated amount of money that the right holder of the absorption source can obtain by the sale of the carbon credit is, for example, an amount obtained by subtracting, from the estimated value of the amount of the carbon credit, expenses (including commissions and the like) necessary from the acquisition to the sale of the carbon credit, such as expenses and commissions. This necessary expense is the estimated amount of the necessary expense. The approximate amount-of-money presentation unit 113 may present information including an estimated value of the amount of the carbon credit and an estimated amount of money that the right holder of the absorption source can obtain by the sale of the carbon credit as the information about the approximate amount of money of revenue resulting from the sale of the carbon credit of the absorption source.

### Operation

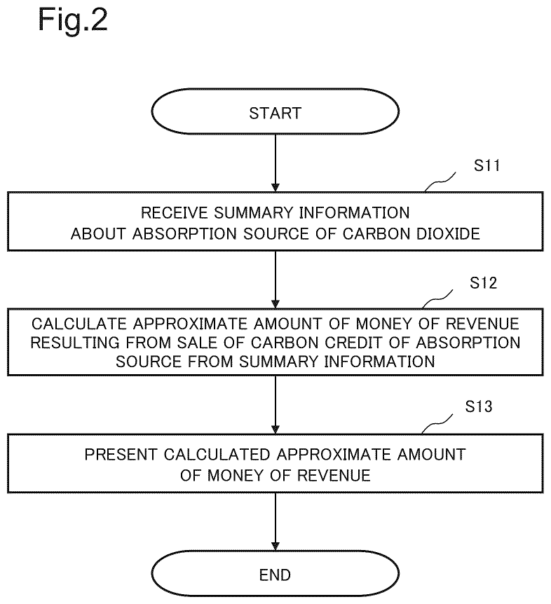

FIG. 2 is a flowchart illustrating an example of an operation of the management system according to the first example embodiment of the present disclosure. In the example illustrated in FIG. 2, first, the summary information reception unit 111 receives summary information of an absorption source of carbon dioxide (step S11). Next, the approximate calculation unit 112 calculates, from the summary information, an approximate amount of money of revenue resulting from the sale of the carbon credit of the absorption source (step S12). The approximate amount-of-money presentation unit 113 presents the calculated approximate amount of money of the revenue (step S13).

### Effects

The present example embodiment described above has an effect of supporting determination as to whether to create a carbon credit.

This is because the approximate calculation unit 112 calculates an approximate amount of money of the amount of revenue resulting from the sale of a carbon credit of the absorption source from the summary information about the absorption source of carbon dioxide, and the approximate amount-of-money presentation unit 113 presents the calculated approximate amount of money of the revenue. In general, the amount of money of a carbon credit of the absorption source is calculated using the absorption amount of carbon dioxide calculated using a calculation expression selected according to the absorption source. The calculation of the amount of money of a carbon credit of the absorption source requires specialized knowledge. Therefore, it is difficult for a person who does not have specialized knowledge to calculate the amount of money of a carbon credit of the absorption source and to estimate a rough amount of money. Therefore, it is difficult for a person who does not have specialized knowledge to determine whether to create the carbon credit of the absorption source based on a result of comparison between the amount of revenue resulting from the operation of the absorption source and the expected amount of revenue resulting from the sale of the carbon credit of the absorption source. According to the present example embodiment, information about the calculated approximate amount of money of revenue by selling the carbon credit of the absorption source is obtained. Therefore, according to the present example embodiment, even a person who does not have specialized knowledge can determine whether to create the carbon credit of the absorption source based on the comparison result between the amount of revenue resulting from the operation of the absorption source and the approximate amount of money of revenue resulting from the sale of the carbon credit of the absorption source. Therefore, the present example embodiment has an effect of supporting determination as to whether to create a carbon credit.

### Second Example Embodiment

Next, the second example embodiment of the present disclosure will be described in detail with reference to the drawings.

### Configuration

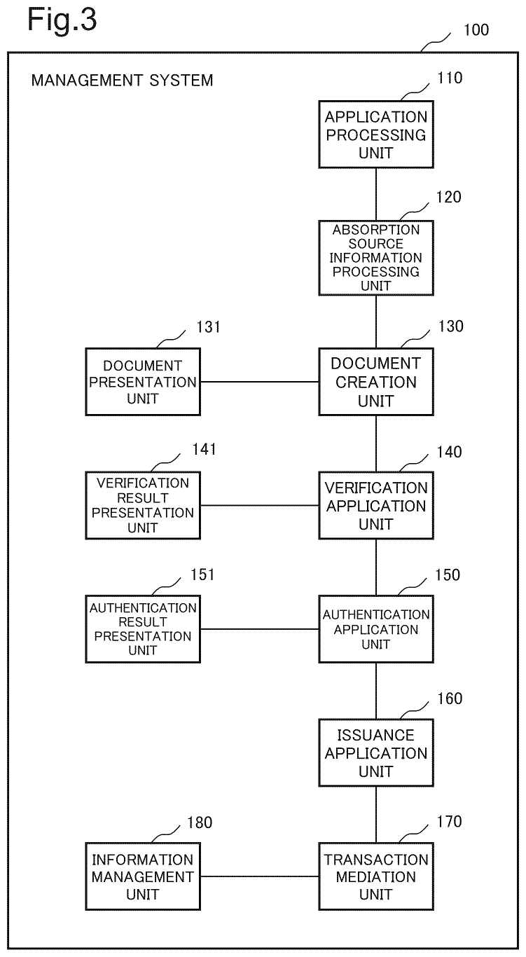

FIG. 3 is a block diagram illustrating an example of a configuration of a management system according to the second example embodiment of the present disclosure. In the example illustrated in FIG. 3, a management system 100 of the present disclosure includes an application processing unit 110, an absorption source information processing unit 120, a document creation unit 130, a document presentation unit 131, a verification application unit 140, a verification result presentation unit 141, an authentication application unit 150, an authentication result presentation unit 151, an issuance application unit 160, a transaction mediation unit 170, and an information management unit 180. The management system 100 is communicably connected to a communication network.

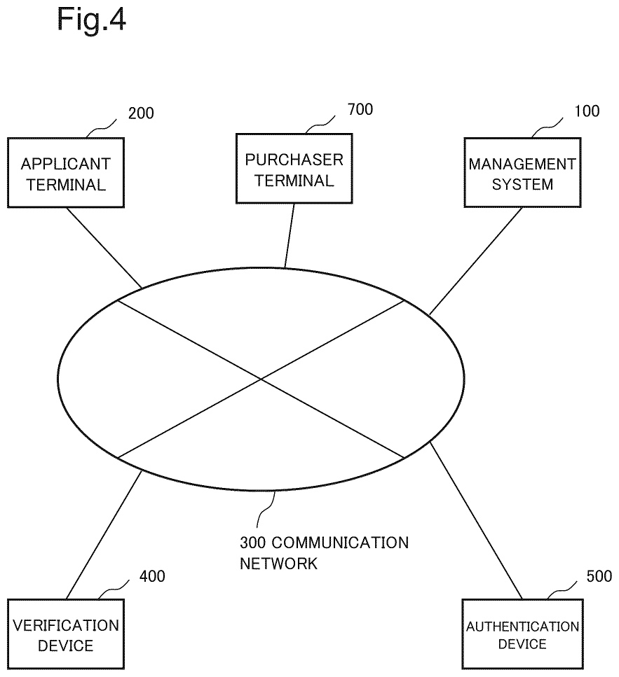

FIG. 4 is a diagram schematically illustrating a communication network to which the management system according to the second example embodiment of the present disclosure is connected and a device connected to the communication network. In the example illustrated in FIG. 4, the management system 100 is communicably connected to a communication network 300. An applicant terminal 200, a verification device 400, an authentication device 500, and a purchaser terminal 700 are further communicably connected to the communication network 300. The management system 100 can communicate with each of the applicant terminal 200, the verification device 400, the authentication device 500, and the purchaser terminal 700 via the communication network 300. The applicant terminal 200, the verification device 400, and the authentication device 500 may also be able to communicate with each other.

### Applicant Terminal 200

The applicant terminal 200 is a terminal device used by the applicant. The applicant is a person who applies for creation of a carbon credit. The applicant is, for example, a right holder of the absorption source.

The applicant inputs information to the applicant terminal 200 using an input device such as a keyboard and a mouse or a touch panel of the applicant terminal 200. The applicant terminal 200 transmits the input information to the management system 100 via the communication network 300. The applicant terminal 200 receives information from the management system 100 via the communication network 300. The applicant terminal 200 presents the information received from the management system 100 to the applicant by displaying the information received from the management system 100 on a display device such as a display or a touch panel of the applicant terminal 200. That is, the management system 100 presents the information to the applicant by transmitting the information to the applicant terminal 200 and displaying the received information on the display device of the applicant terminal 200.

### Verification Device 400

The verification device 400 is an information processing device managed by a verification organization. The verification organization is an organization (for example, a company or another entity) that verifies the description of a carbon credit project. The verification of the carbon credit project description is specifically verification of the format of the carbon credit project description, that is, verification of whether the carbon credit project description satisfies the criteria of the format.

The verification device 400 receives a description of the carbon credit project and an application for verification of the description (specifically, information for requesting verification of the description) from the management system 100. The verification device 400 displays the received description on a display device such as a display or a touch panel of the verification device 400.

The person in charge of verification of the verification organization verifies the received description, and inputs the verification result to the verification device 400 via an input device such as a keyboard and a mouse, or a touch panel of the verification device 400.

The verification device 400 notifies the management system 100 of the result of the authentication. For example, the verification device 400 transmits information indicating a verification result (that is, information indicating that the verification result is a pass or information indicating that the verification result is a failure) to the management system 100 via the communication network 300. The verification device 400 may transmit information indicating that the verification is completed to the management system 100. When receiving the information indicating that the verification is completed, the management system 100 may acquire the information indicating the result of the verification from the verification device 400.

### Authentication Device 500

The authentication device 500 is an information processing device managed by an authentication organization. The authentication organization is an organization (for example, a company or another entity) that authenticates the carbon credit description. The authentication of the carbon credit description is authentication of the content of the carbon credit description. That is, the authentication organization (specifically, the person in charge of the authentication organization) determines whether the content of the description of the carbon credit is appropriate, for example, through visit and investigation by a person in charge to a place described in the description. In a case where the content of the carbon credit description is valid, the authentication organization generates information certifying the content of the carbon credit description.

In the present example embodiment, the verification device 400 receives a carbon credit description and an application for authentication of the carbon credit description (specifically, information for requesting authentication of the description) from the management system 100. In the present example embodiment, the authentication device 500 receives the description and the application for authentication of the description from the management system 100. The application for authentication of the carbon credit description may include information indicating that the verification result of the description is a pass. The authentication device 500 displays the received description on a display device such as a display or a touch panel of the authentication device 500.

The person in charge of authentication of the authentication organization performs a process of authentication of the received description, and inputs a result of the authentication to the authentication device 500 via an input device such as a keyboard and a mouse, or a touch panel of the authentication device 500.

The authentication device 500 notifies the management system 100 of the result of the authentication. The authentication device 500 transmits, for example, information (that is, information indicating that the result of the authentication is a pass or information indicating that the result of the authentication is a failure) indicating a result of the authentication to the management system 100 via the communication network 300. The authentication device 500 may transmit information indicating that the authentication is completed to the management system 100. When receiving the information indicating that the authentication is completed, the management system 100 may acquire the information indicating the result of the authentication from the authentication device 500.

### Purchaser Terminal 700

The purchaser terminal 700 is a terminal device used by a carbon credit purchase desiring person. The purchaser terminal 700 transmits the condition of the carbon credit desired to be purchased to the transaction mediation unit 170 of the management system 100 according to the instruction of the purchase desiring person input using the input device of the purchaser terminal 700. The purchaser terminal 700 receives the information about the carbon credit matching the condition from the transaction mediation unit 170, and displays the received information about the carbon credit on the display device of the purchaser terminal 700. The purchaser terminal 700 transmits, to the transaction mediation unit 170, information indicating an offer to purchase a carbon credit selected by the purchase desiring person using the input device from the carbon credit of which the information has been received.

### Management System 100

The application processing unit 110 of the management system 100 receives an application for creation of a carbon credit from the applicant terminal 200 (specifically, an applicant who operates the applicant terminal 200).

The absorption source information processing unit 120 of the management system 100 receives information about an absorption source that is a target for creation of a carbon credit from the applicant terminal 200 (specifically, an applicant who operates the applicant terminal 200).

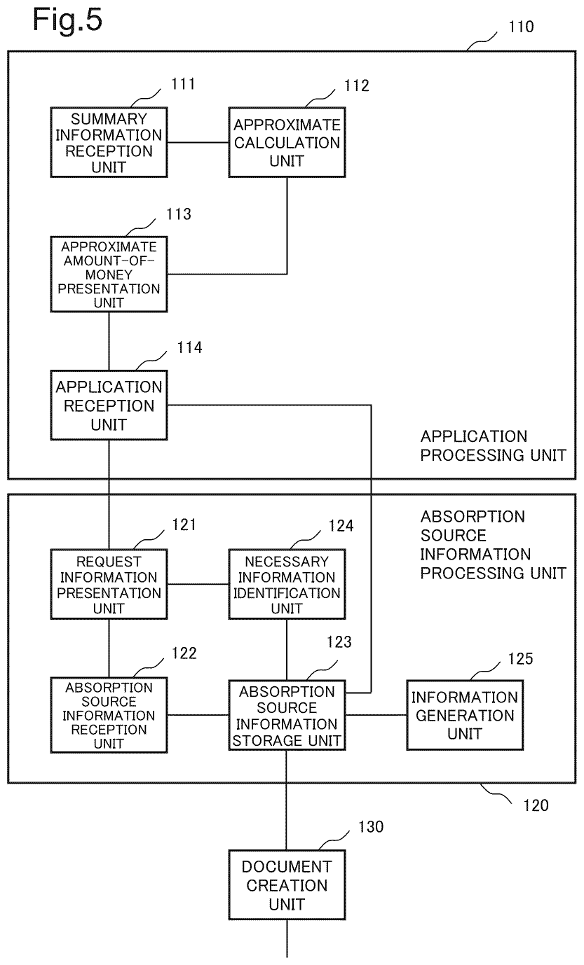

FIG. 5 is a block diagram illustrating an example of configurations of the application processing unit 110 and the absorption source information processing unit 120 of the management system 100 according to the second example embodiment of the present disclosure. The application processing unit 110 of the present example embodiment includes a summary information reception unit 111, an approximate calculation unit 112, an approximate amount-of-money presentation unit 113, and an application reception unit 114. The absorption source information processing unit 120 of the present example embodiment includes a request information presentation unit 121, an absorption source information reception unit 122, an absorption source information storage unit 123, a necessary information identification unit 124, and an information generation unit 125.

### Summary Information Reception Unit 111

The summary information reception unit 111 receives summary information of an absorption source that is a target of creation of a carbon credit. The summary information reception unit 111 receives, for example, the summary information input by the operator of the applicant terminal 200 from the applicant terminal 200. In the following description, the operator of the applicant terminal 200 who inputs the summary information is referred to as an application desiring person for creation of a carbon credit. An application desiring person who wishes to create a carbon credit is also simply described as an application desiring person.

The summary information is information about the absorption source. As described above, the absorption amount of carbon dioxide by the absorption source is described in the project description. In order to calculate the absorption amount of carbon dioxide, information about the absorption source (that is, the absorption source information) as in the example described later is used. The summary information is information less than the absorption source information used for calculating the absorption amount of carbon dioxide by the absorption source described in the description of the project.

As described above, the absorption source information is information about the absorption source including information necessary for generating a description of a project. The absorption source information includes, for example, a plurality of types of information (for example, the location of the absorption source, the total area, the tree species, the area for each tree species, the current situation, the future operation schedule, and the like) regarding the absorption source. A specific example of the absorption source information will be described in detail later. The project description is a document in which predetermined information is described in a predetermined format. The project description is also referred to as a project description in the present disclosure.

In other words, the summary information is information for simply calculating the absorption amount of carbon dioxide in the absorption source for calculating the approximate amount of money of a carbon credit of the absorption source. The absorption amount (that is, the approximate value of the absorption amount calculated by an absorption amount approximate calculation unit 1122 to be described later) of carbon dioxide calculated from the summary information does not depend on the accuracy (in other words, the accuracy of the absorption amount of carbon dioxide required by the authentication organization) of the absorption amount of carbon dioxide described in the description of the project. The accuracy of the approximate value of the absorption amount calculated from the summary information by the absorption amount approximate calculation unit 1122 to be described later may be lower than the accuracy of the absorption amount of carbon dioxide required by the authentication organization. The summary information includes, for example, at least any one of part of the absorption source information, an approximate value of numerical information included in the absorption source information, and information about a group of absorbers included in the absorption source information. The information about the group of absorbers is, for example, information indicating the group. In a case where the absorber is a tree and the absorption source information includes information that the type of the absorber in the absorption source is the type of tree (that is, the tree species), the summary information may include information indicating any one of the groups of types of trees (for example, a conifer and a broad-leaved tree) as the information indicating the group of absorbers. The summary information may include group information of matters other than the absorber in which the information is used for calculating the absorption amount of carbon dioxide.

The summary information includes, for example, one or more types of information about the absorption source. Specifically, the summary information may include, for example, information indicating a location, an area, a tree species category, a current situation, and a future operation schedule of the absorption source.

The location of the absorption source is information for identifying a municipality where the absorption source is located. In a case where the location of the absorption source is across a plurality of municipalities, the location of the absorption source is, for example, a municipality including the widest part of the absorption source.

The area of the absorption source is an area of the absorption source represented by a predetermined unit. The area of the absorption source is not necessarily strictly accurate.

The tree species category represents, for example, a category of the type of the most dominant tree among trees growing in the absorption source. Among trees planted in the absorption source, the most dominant tree may be the type of tree having the largest number of trees among trees planted in the absorption source. Among trees growing in the absorption source, the most main tree may be a type of tree having the largest area of a distribution region among trees growing in the absorption source. The category of the tree type may be a classification of trees such as a conifer and a broad-leaved tree. The classification of trees is not limited to this example. The category of the tree type may be a species that is a basic unit of a tree in a biological classification. The types of trees are not limited to the above examples.

The current situation represents the current situation of operation of the forest. Specifically, the current situation may indicate a situation of forest operation in a predetermined period in the past. This predetermined period is, for example, a period set as a period longer than a general tree trimming interval (for example, several decades) in a case where a tree is used as a tree. The current situation indicates, for example, that trees are regularly cut down or that nothing is done. In this case, tree thinning may not be included in tree trimming. In a case where the absorption source includes a region where regular trimming is performed and a region where no trimming is performed, the current situation may indicate a situation in a region having a large area among these two regions. In a case where tree trimming was performed not necessarily periodically but once or more in a predetermined period in the past, information indicating that the tree trimming is performed periodically may be input as the current situation.

The future operation schedule is a schedule of tree trimming of the absorption source in a case where the carbon credit of the absorption source is approved. The tree trimming schedule specifically indicates, for example, performing trimming in the absorption source or protecting trees without performing trimming in the absorption source. The plan of the future operation may be a plan of the future operation according to the current intention of the application desiring person input by the application desiring person.

The summary information is not limited to the above example.

Hereinafter, comparison between the absorption source information and the summary information will be described. The summary information is information in which at least one of the type of the included information and the fineness of the value of at least one type of the included information is less than that of the absorption source information. In other words, the summary information being less than the absorption source information means that at least one of the type of information included in the summary information and the fineness of the value of at least one type of information included in the summary information is less than that of the absorption source information.

Specifically, the summary information being less than the absorption source information means that, for example, the number of parameters included in the summary information is less than the number of parameters included in the absorption source information. For example, the summary information includes, as parameters, for example, a location of the absorption source, an area of the absorption source, a category of tree species of the absorption source, a current operation state of the absorption source, and a future operation plan of the absorption source. The absorption source information may include, as parameters, for example, a location of the absorption source, an area of the absorption source, a distribution of tree species of the absorption source, a current operation state of the absorption source, a future operation plan of the absorption source, a distribution of soil, other information, and the like. In such a case, the number of parameters included in the summary information is smaller than the number of parameters included in the absorption source information.

The summary information being less than the absorption source information means that, for example, the number of values that can be taken by the parameter included in the summary information is less than the number of values that can be taken by the related parameter included in the absorption source information. The category of the tree species of the absorption source included in the summary information as the parameter is set in such a way as to be able to take, for example, two values of a value representing a conifer and a value representing a broad-leaved tree. The tree species related to the category of the tree species of the absorption source that the absorption source information includes as the parameter may be set in such a way as to be able to take various values respectively representing various species and subspecies on the biology of the tree.

The summary information being less than the absorption source information may be, for example, that the number of parameters representing a certain item in the summary information is less than the number of parameters representing the same item in the absorption source information. For example, in the summary information, the distribution of the vegetation of the absorption source may be represented by a tree species category. As described above, the values that can be taken by the tree species category are, for example, values representing a conifer and values representing a broad-leaved tree. In this case, the value representing a conifer represents that the vegetation is conifers in the entire area of the absorption source. The value representing broad-leaved trees indicates that the vegetation is broad-leaved trees over the entire area of the absorption source. In the absorption source information, the distribution of the vegetation may be represented by the tree species and a two-dimensional distribution of the tree species.

Similarly, the parameter indicating the current operation state of the absorption source in the summary information may be set to take a value indicating that tree trimming is periodically performed in the entire area of the absorption source or a value indicating that no tree trimming is performed in the entire area of the absorption source. The parameter representing the current operation state of the absorption source in the absorption source information may be represented by a two-dimensional distribution (that is, the two-dimensional distribution of the region where tree trimming is periodically performed and the two-dimensional distribution of the region where no tree trimming is performed are described) of the region for each current operation state of the absorption source. The same applies to a future operation plan of the absorption source.

The summary information may be set to include a parameter in which a plurality of parameters of the absorption source information is integrated instead of the plurality of parameters of the absorption source information. For example, the absorption source information may include the total area of the absorption source and the area of each tree species of the absorption source as parameters, and the summary information may include the area of the absorption source as a parameter.

The summary information being less than the absorption source information may indicate a state in which at least any one of the above examples is combined.

As described above, the summary information is information including at least any one of part of the parameters of the absorption source information (corresponding to the type of information described above) and a parameter in which the number of values that can be taken by the parameter of the absorption source information is reduced. The parameter in which the number of values that can be taken by the parameter of the absorption source information is reduced indicates a parameter of the type same as the parameter of the absorption source information that can take any of a plurality of values whose number is smaller than N in a case where the value of the parameter of the absorption source information is any of N values. The summary information may be identical to the absorption source information.

The summary information reception unit 111 may display a user interface for inputting the summary information on the display device of the applicant terminal 200. In this case, the summary information reception unit 111 receives the summary information input using the user interface for inputting the summary information displayed on the display device of the applicant terminal 200 from the applicant terminal 200.

### Approximate Calculation Unit 112

The approximate calculation unit 112 calculates an approximate amount of money of a carbon credit of the absorption source from the summary information received by the summary information reception unit 111. The approximate amount of money of the carbon credit of the absorption source is an estimated amount of money of the carbon credit of the absorption source calculated using the summary information. The approximate calculation unit 112 may calculate, as the approximate amount of money of the carbon credit of the absorption source, at least one of an approximate value of the sale amount of the carbon credit and an approximate amount of money of revenue that the applicant will obtain by selling the carbon credit (for example, the amount obtained by subtracting the approximate value of expenses from the approximate value of the sale amount).

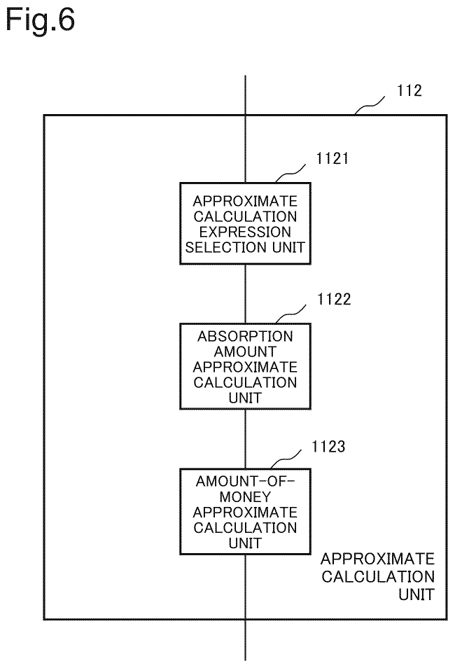

FIG. 6 is a block diagram illustrating an example of a configuration of the approximate calculation unit 112 of the management system 100 according to the second example embodiment of the present disclosure.

In the example illustrated in FIG. 6, the approximate calculation unit 112 includes an approximate calculation expression selection unit 1121, an absorption amount approximate calculation unit 1122, and an amount-of-money approximate calculation unit 1123.

### Approximate Calculation Expression Selection Unit 1121

The approximate calculation expression selection unit 1121 selects an approximate calculation expression for calculating the absorption amount of carbon dioxide by the absorption source per unit area in a predetermined period from a plurality of approximate calculation expressions using the summary information.

Each of the plurality of approximate calculation expressions is determined according to at least some of the values of the summary information. Each of the plurality of approximate calculation expressions is associated with, for example, a condition for a value of at least some types of summary information among the summary information. Each approximate calculation expression of the plurality of approximate calculation expressions is a expression representing the absorption amount of carbon dioxide by the absorption source per unit area in a predetermined period in a case where the value of the summary information about the absorption source satisfies the condition associated with the approximate calculation expression. Each of these conditions is represented by a combination of values (or value range) of at least some types of summary information among the summary information. In a case where the values of all types of summary information indicating the conditions in the summary information about the absorption source are values indicating the conditions (alternatively, in a case where the values are included in the range of values representing the condition), the conditions are satisfied. The condition associated with each of the plurality of approximate calculation expressions is set in such a way that two conditions are not satisfied at the same time.

The approximate calculation expression selection unit 1121 selects an approximate calculation expression associated with a condition satisfied by the received summary information. Specifically, for example, the approximate calculation expression selection unit 1121 extracts a value for selecting an approximate calculation expression from the summary information, and selects an approximate calculation expression associated with a condition satisfied by the extracted value.

The condition associated with the approximate calculation expression is represented by, for example, a combination of a value representing the climate at the location of the absorption source, a value representing the tree species of the trees of the absorption source, a value representing the current status of operation, and a value representing the schedule of future operation. In a case where a value representing the climate at the location of the absorption source, a value representing the tree species of the trees of the absorption source, a value representing the current status of operation, and a value representing the schedule of future operation included in the received summary information respectively coincide with those values included in the condition, the condition is satisfied. In this case, the approximate calculation expression selection unit 1121 identifies a value representing the climate at the location of the absorption source included in the received summary information. At this time, the approximate calculation expression selection unit 1121 holds in advance information indicating a geographical distribution of the climate, for example. The approximate calculation expression selection unit 1121 identifies the climate (that is, a value representing climate) at the location from the information indicating the geographical distribution of the climate. The value representing the climate may be, for example, at least any one of a value representing an average temperature, a value representing an average altitude, a value representing a combination of latitude and longitude of a representative point, and a value representing a transition of an average temperature for each predetermined period (for example, every month). The representative point is, for example, a point (for example, the center of gravity, the center of a circumscribed circle, or the like) determined by a predetermined rule for the range of the absorption source. The value representing the climate may include at least any one of the annual precipitation amount and the transition of the average precipitation amount for each predetermined period (for example, month). The value representing the climate is not limited to the above example. The approximate calculation expression selection unit 1121 selects an approximate calculation expression associated with a combination of the identified value representing the climate at the location of the absorption source and the value representing the tree species of the trees of the absorption source, the value representing the current status of operation, and the value representing the schedule of future operation included in the received summary information.

At least some of the plurality of approximate calculation expressions may be expressions of the same form represented by one or more coefficients and one or more variables. At least some of the plurality of approximate calculation expressions may be, for example, expressions for calculating the absorption amount of carbon dioxide by the absorption source by multiplying a value representing the absorption amount of carbon dioxide per unit area as a coefficient by a value of the area of the absorption source as a variable. In this case, the coefficient is a value representing the absorption amount of carbon dioxide per unit area determined by the climate at the location of the absorption source and the tree species category. In this example, the approximate calculation expressions with different coefficients are different approximate calculation expressions.

### Absorption Amount Approximate Calculation Unit 1122

The absorption amount approximate calculation unit 1122 calculates an approximate value of the absorption amount of carbon dioxide by the absorption source from the summary information about the absorption source using the selected approximate calculation expression. The calculated approximate value of the absorption amount of carbon dioxide by the absorption source is, for example, an approximate value of the weight of carbon dioxide absorbed by the absorption source in a period from the present to a future predetermined time (in other words, a future predetermined period).

The absorption amount of carbon dioxide absorbed by the absorption source is used to calculate the amount of money of a carbon credit. The absorption amount of carbon dioxide in the absorption source used for calculating the amount of the carbon credit is an absorption amount calculated as an estimated value of the absorption amount of carbon dioxide in a predetermined period. The future predetermined period is identical to the predetermined period.

The absorption amount approximate calculation unit 1122 may calculate an approximate value of the weight of carbon dioxide absorbed by the absorption source in a plurality of future predetermined periods (for example, a period from the present to one year later, a period from the present to 30 years later, and the like). The plurality of future predetermined periods and the number thereof are not limited to the above example. In this case, one of the plurality of future predetermined periods is the above-described predetermined period.

### Amount-of-Money Approximate Calculation Unit 1123

The amount-of-money approximate calculation unit 1123 calculates, from the absorption amount of carbon dioxide by the absorption source, the absorption amount being approximated by the absorption amount approximate calculation unit 1122, an approximate amount of money of revenue resulting from the sale of a carbon credit of the absorption source.

The approximate amount of money of revenue resulting from the sale of the carbon credit of the absorption source may be, for example, an estimated value of the amount of money of a carbon credit calculated from an estimated value of the absorption amount of carbon dioxide by the absorption source estimated from the summary information. As the estimated value of the amount of the carbon credit, the amount-of-money approximate calculation unit 1123 calculates, for example, the product of the amount of money per unit absorption amount of absorption of carbon dioxide (that is, the market value) at the time of calculating the approximate amount of money of revenue and the approximate absorption amount of absorption of carbon dioxide by the absorption source, the absorption amount being approximated. The approximate amount of money of revenue resulting from the sale of the carbon credit of the absorption source may be, for example, an estimated amount of money that the right holder of the absorption source can obtain by the sale of the carbon credit. The estimated amount of money that the right holder of the absorption source can obtain by the sale of the carbon credit is, for example, an amount obtained by subtracting, from the estimated value of the amount of the carbon credit, expenses (including commissions and the like) necessary from the acquisition to the sale of the carbon credit, such as expenses and commissions. This necessary expense is the estimated amount of the necessary expense. The estimated amount of necessary expenses is, for example, an amount of money generally determined in advance as the amount of necessary expenses.

### Approximate Amount-of-Money Presentation Unit 113

The approximate amount-of-money presentation unit 113 presents an approximate amount of money of revenue resulting from the sale of the carbon credit of the absorption source, the approximate amount being approximated. The approximate amount-of-money presentation unit 113 transmits, for example, the approximate amount of money of revenue resulting from the sale of the carbon credit of the absorption source to the applicant terminal 200, and causes the applicant terminal 200 to display the transmitted approximate amount of money of revenue.

The approximate amount-of-money presentation unit 113 may present, in addition to the approximate amount of money of revenue, the input summary information and at least part of the information calculated in the process of calculating the approximate amount (for example, the absorption amount of carbon dioxide). In other words, for example, in addition to the approximate amount of money of revenue resulting from the sale of the carbon credit of the absorption source, the approximate amount-of-money presentation unit 113 transmits the input summary information and at least part of the information calculated in the process of calculating the approximate amount to the applicant terminal 200, and causes the applicant terminal 200 to display the transmitted approximate amount of money of revenue, the summary information, and at least part of the information calculated in the process of calculating the approximate amount.

The approximate amount-of-money presentation unit 113 may present at least one of an estimated value of the amount of the carbon credit and an estimated amount of money that the right holder of the absorption source can obtain by the sale of the carbon credit as information about the approximate amount of money of revenue resulting from the sale of the carbon credit of the absorption source. The approximate amount-of-money presentation unit 113 may present information including an estimated value of the amount of the carbon credit and an estimated amount of money that the right holder of the absorption source can obtain by the sale of the carbon credit as the information about the approximate amount of money of revenue resulting from the sale of the carbon credit of the absorption source.

### Application Reception Unit 114

The application reception unit 114 receives an application for creation of a carbon credit after the information about the approximate amount of money of revenue resulting from the sale of the carbon credit of the absorption source is presented.

The application for creation of a carbon credit is, for example, information indicating that an operator (in other words, the application desiring person for creation of a carbon credit) of the applicant terminal 200 agrees to create a carbon credit for an absorption source. The application for creation of a carbon credit includes, for example, information for identifying the operator of the applicant terminal 200 and information for requesting creation of a carbon credit of an absorption source as information for agreeing to the creation of the carbon credit.

In a case of receiving the application for creation of a carbon credit, the application reception unit 114 registers the operator of the applicant terminal 200 as an applicant for creation of a carbon credit. Specifically, in a case of receiving the application for creation of a carbon credit, the application reception unit 114 stores information about the operator of the applicant terminal 200 in, for example, the absorption source information storage unit 123 as information about the applicant for creation of a carbon credit.

The application reception unit 114 receives, as the information about the applicant, for example, information identifying the applicant, an address of the applicant, an e-mail of the applicant, and the like, and registers the received information. The information about the applicant is not limited to these examples.

### Request Information Presentation Unit 121

The request information presentation unit 121 presents a request for information to be used for creating a carbon credit. The request for information to be used for creating a carbon credit is information that encourages provision of information to be used for creating the carbon credit. The request information presentation unit 121 may transmit a request for information to be used for creating a carbon credit to the applicant terminal 200, for example, and display the received request on the applicant terminal 200, thereby presenting the request for information to be used for creating the carbon credit to the applicant (specifically, the applicant terminal 200).

The information to be used for creating the carbon credit is, for example, information that proves the eligibility of the applicant, absorption source information, and the like.

The request information presentation unit 121 may display, as a request for information to be used for creating a carbon credit, for example, a user interface for inputting information for proving eligibility of an applicant, absorption source information, and the like exemplified below.

Upon receiving information indicating the type of missing information from the necessary information identification unit 124 to be described in detail later, the request information presentation unit 121 presents a request for the missing information. The request information presentation unit 121 presents a request for the missing information to the applicant (specifically, the applicant terminal 200). In other words, the request information presentation unit 121 transmits the request for the missing information to the applicant terminal 200 and causes the applicant terminal 200 to display the request for the missing information.

### Example of Information Proving Eligibility of Applicant

The information proving the eligibility of the applicant is identity confirmation information about the applicant, information proving that the applicant has a right to request creation of a carbon credit of an absorption source (hereinafter, also referred to as attestation information), and the like. The identity confirmation information is, for example, a copy of a document or the like, such as a driver's license, a passport, or a My Number Card, that certifies that the applicant is the applicant himself/herself. The copy is, for example, image data capable of confirming the description of a document or the like, such as a captured image or a scanned image. The attestation information is, for example, a copy of a document proving that the applicant possesses the absorption source. The accounting attestation information may be, for example, a copy of a document proving that the owner of the absorption source owns the absorption source, and a copy of a document proving that the application for creation of a carbon credit has been delegated by the owner of the absorption source to the applicant. In a case where more than one owner owns the absorption source, the attestation information may be, for example, a copy of a document proving that the owner owns the absorption source with respect to all owners of the absorption source, and a copy of a document proving that the application for creation of a carbon credit has been delegated by all owners of the absorption source to the applicant. The applicant may be one of a plurality of owners of the absorption source. In this case, a copy of a document that certifies that the application for creation of a carbon credit has been delegated by the applicant to the applicant.

### Example of Absorption Source Information

As described above, the absorption source information is information about the absorption source including information necessary for generating a description of a project. Specifically, the absorption source information includes information identifying the range of the absorption source. The absorption source information may include an area (alternatively, information indicating the ratio of the area for the type of vegetation to the range of the absorption source) for each type of vegetation (that is, types of trees). The information about the area for each type of vegetation may be information about the distribution in the absorption source for each type of vegetation. Subspecies of trees may be treated as different types. The absorption source information may include information about a ratio of an area of a region where periodic trimming is performed and a ratio of an area of a region where no trimming is performed for each type of tree. The information about the ratio of the area of the region where the periodic tree trimming is performed and the ratio of the area of the region where no tree trimming is performed may be information about the distribution of the region where the periodic tree trimming is performed and the distribution of the region where no tree trimming is performed in the absorption source. The absorption source information may include information indicating the presence or absence of forest protection after the carbon credit is created. The information indicating the presence or absence of forest protection after the carbon credit is created may be information indicating that tree trimming is scheduled to be periodically performed in the entire absorption source, or information indicating that no tree trimming trees is performed and forests are protected in the entire absorption source. The information indicating the presence or absence of forest protection after the carbon credit is created may be information about the distribution of the area in which tree trimming is not performed and forests are protected, and the distribution of the area in which regular tree trimming is scheduled to be performed, after the carbon credit is created. The absorption source information may include information indicating a distribution for each type of soil of the absorption source. The absorption source information may include other information.

### Absorption Source Information Reception Unit 122

In response to the presentation of the request for information to be used for creating a carbon credit, the absorption source information reception unit 122 receives, from the applicant terminal 200, information to be used for creating the carbon credit, the information having been input via the user interface described above, for example. The absorption source information reception unit 122 stores the received information in the absorption source information storage unit 123.

The request information presentation unit 121 may present to the applicant terminal 200 an inquiry about the date and time of the interview in which the date and time at which the applicant can undergo an interview is inquired according to an instruction input by the operator of the management system 100 using the input device of the management system 100. The absorption source information reception unit 122 may receive, from the applicant terminal 200, information about the date and time at which the applicant can undergo an interview, the information being input in response to the presentation of the inquiry about the date and time of the interview. The request information presentation unit 121 may display the above-described interface on the display device of the management system 100. The operator of the management system 100 may input, to the management system 100, at least part of the information to be used for creating the carbon credit, the information being obtained through an interview with the applicant, using the input device of the management system 100. In this case, the absorption source information reception unit 122 receives, by the operator of the management system 100, at least part of the information to be used for creating the carbon credit, the information being input using the input device of the management system 100. The absorption source information reception unit 122 stores the received information in the absorption source information storage unit 123.

### Absorption Source Information Storage Unit 123

The absorption source information storage unit 123 stores information about the applicant stored by the application reception unit 114. The absorption source information storage unit 123 stores information to be used for creating a carbon credit, the information being stored by the absorption source information reception unit 122. The absorption source information storage unit 123 further stores the information generated by the information generation unit 125, the information being stored by the information generation unit 125. The information generated by the information generation unit 125 will be described later.

### Necessary Information Identification Unit 124

The necessary information identification unit 124 identifies, as missing information, information that is not stored in the absorption source information storage unit 123 among the information (that is, information necessary for creation of a carbon credit) to be used for creating a carbon credit that is required to be input by the applicant or the like. The necessary information identification unit 124 holds in advance the type of information to be used for creating the carbon credit that is required to be input by the applicant or the like. The necessary information identification unit 124 transmits information indicating the type of the missing information to the request information presentation unit 121.

As described above, upon receiving the information indicating the type of the missing information, the request information presentation unit 121 presents the request for the missing information.

Upon receiving the information indicating the type of the missing information, the request information presentation unit 121 presents a request for the missing information to, for example, an applicant (specifically, the applicant terminal 200). In this case, the absorption source information reception unit 122 receives the missing information input by the applicant using the input device of the applicant terminal 200 from the applicant terminal 200.

Upon receiving the information indicating the type of the missing information, the request information presentation unit 121 presents a request for the missing information to, for example, an operator of the management system 100. Specifically, the request information presentation unit 121 displays the request for the missing information on the display device of the management system 100. In this case, the operator of the management system 100 inputs, for example, missing information obtained through an interview with the input person using the input device of the management system 100. The absorption source information reception unit 122 receives the missing information input by the operator of the management system 100 using the input device of the management system 100.

### Information Generation Unit 125

The information generation unit 125 generates at least part of the information described in the carbon credit description from the information about the absorption source stored in the absorption source information storage unit 123. The information generated by the information generation unit 125 includes information about the absorption amount of carbon dioxide absorbed by the absorption source in a future predetermined period. The information generation unit 125 stores the generated information in the absorption source information storage unit 123.

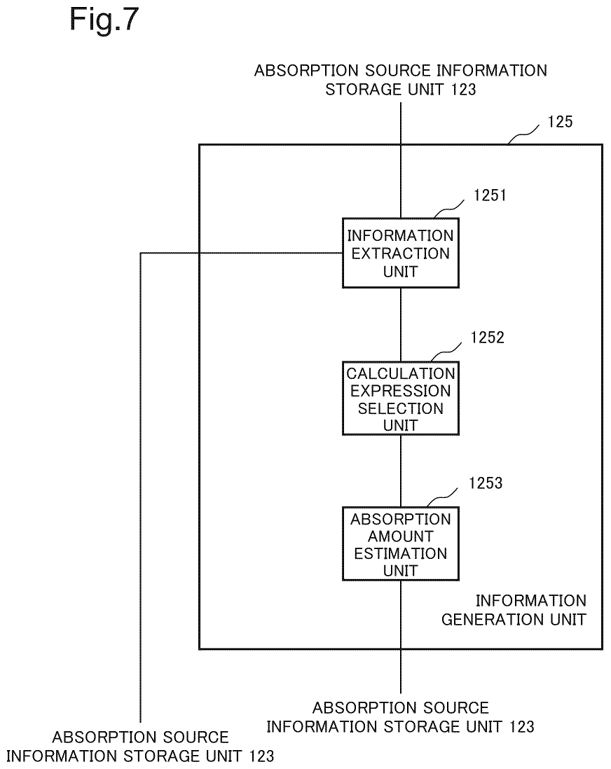

FIG. 7 is a block diagram illustrating an example of a configuration of the information generation unit 125 of the management system 100 according to the second example embodiment of the present disclosure. In the example illustrated in FIG. 7, the information generation unit 125 includes an information extraction unit 1251, a calculation expression selection unit 1252, and an absorption amount estimation unit 1253.

### Information Extraction Unit 1251

The information extraction unit 1251 extracts information described in the description of the carbon credit from the information about the absorption source stored in the absorption source information storage unit 123. The information extraction unit 1251 may calculate or generate information described in the carbon credit description from the information about the absorption source stored in the absorption source information storage unit 123. The information extracted, calculated, or generated by the information extraction unit 1251 is at least part of the information described in the description of the carbon credit. The information extraction unit 1251 may extract, for example, an area of a region where trees are growing for each type of tree in the absorption source as the information described in the description of the carbon credit. The information extraction unit 1251 may extract, for example, an area of a region where the soil is distributed on the surface of the ground for each type of soil in the absorption source as the information described in the description of the carbon credit. The information extraction unit 1251 may calculate, for example, an estimated value of the volume of trees for each tree type in the absorption source as the information described in the description of the carbon credit. In this case, for example, the information extraction unit 1251 holds in advance a value of a volume of trees per unit growth area according to a time elapsed after tree trimming is performed. Information about the planar distribution of the time elapsed after tree planting is performed after tree trimming in the absorption source is received by the absorption source information reception unit 122 as information about the absorption source and stored in the absorption source information storage unit 123. For example, the information extraction unit 1251 calculates an estimated value of the volume of the trees for each tree type in the absorption source from the value of the volume of the trees per unit growth area according to the time elapsed from the tree trimming, the information about the planar distribution of the time elapsed from the tree trimming in the absorption source, and the information about the distribution for each tree type in the absorption source. The information extracted, calculated, or generated by the information extraction unit 1251 is not limited to the above example.

The information extraction unit 1251 stores information extracted, calculated, or generated from the information about the absorption source stored in the absorption source information storage unit 123 in the format described in the carbon credit description in the absorption source information storage unit 123. This format is, for example, any of a table, a distribution map, a graph, or the like.

The information extraction unit 1251 further extracts information used for calculating the absorption amount of carbon dioxide from the information about the absorption source stored in the absorption source information storage unit 123. The information used for calculating the absorption amount of carbon dioxide includes information used for selecting a calculation expression for calculating the absorption amount of carbon dioxide and information used for calculating the absorption amount of carbon dioxide using the calculation expression. At least part of the information used for selecting the calculation expression for calculating the absorption amount of carbon dioxide may overlap with at least part of the information used for calculating the absorption amount of carbon dioxide using the calculation expression.

The information used for selecting the calculation expression for calculating the absorption amount is, for example, a value representing the climate at the location of the absorption source, the type of trees growing in the absorption source, information representing the presence or absence of periodic tree trimming in the past, information representing the presence or absence of future forest protection, and the like. The information used for selecting the calculation expression for calculating the absorption amount is not limited to these examples. The information used for selecting the calculation expression for calculating the absorption amount may not include at least any one of these examples. The information used for calculating the absorption amount of carbon dioxide using the calculation expression is, for example, an area of a region where trees are growing for each type of trees growing in the absorption source, information indicating the presence or absence of periodic trimming in the past, information indicating the presence or absence of future forest protection, and the like. The information used for calculating the absorption amount of carbon dioxide using the calculation expression is not limited to these examples. The information used for calculating the absorption amount of carbon dioxide may include, for example, a result of observation by remote sensing and information about a model of an absorption source generated by modeling using the result of the observation. The observation by remote sensing is, for example, observation using a measuring instrument mounted on a flying object that is at least any one of an artificial satellite, an airplane, a drone, and the like. The observation result by remote sensing is, for example, data obtained by observing a plurality of observation points in a region including the absorption source in various wavelength regions. The model of the absorption source includes the state of the absorption source (for example, information about the quantity of trees growing in the absorption source for each tree species). The quantity information is, for example, at least any one of the area of the area where trees are growing, the weight of the trees, and the number of trees. The quantity information may be obtained for each predetermined period after planting. The result of observation by remote sensing may include results obtained by a plurality of times of observation. Modeling may include predicting changes in the state of the absorption source. The model of the absorption source may include the state of the absorption source and information indicating a change in the state of the old training. The information used for calculating the absorption amount of carbon dioxide using the calculation expression may not include at least any one of these examples.

The information extraction unit 1251 may display the information (for example, an image or the like) stored in the absorption source information storage unit 123 on the display device of the management system 100. The operator of the management system 100 may input the information about the absorption source read from the information displayed on the display device of the management system 100 to the management system 100 using the input device of the management system 100. The information extraction unit 1251 may store the information input by the operator of the management system 100 using the input device of the management system 100 in the absorption source information storage unit 123.

The information extraction unit 1251 may transmit the information (for example, an image or the like) stored in the absorption source information storage unit 123 to another information processing device capable of communicating with the management system 100. The information extraction unit 1251 may receive the information generated by the information processing device from the information processing device using the information transmitted to the information processing device. The operator of the management system 100 may store the information received from the information processing device in the absorption source information storage unit 123.

### Calculation Expression Selection Unit 1252

The calculation expression selection unit 1252 selects a calculation expression to be used for calculating the absorption amount of carbon dioxide from a plurality of calculation expressions using the information (hereinafter, referred to as condition information) extracted, calculated, or generated by the information extraction unit 1251 and used for selecting a calculation expression for calculating the absorption amount. As in the plurality of approximate calculation expressions described above, a condition for the value of the condition information may be associated with each of the plurality of calculation expressions. The conditions associated with the plurality of calculation expressions may be set in such a way that the plurality of conditions is not satisfied simultaneously, that is, for the same value of the condition information.

The plurality of calculation expressions may include one or more expressions that match any of the plurality of approximate calculation expressions described above. Each of the plurality of calculation expressions may be different from any of the plurality of approximate calculation expressions described above.

### Absorption Amount Estimation Unit 1253

The absorption amount estimation unit 1253 estimates the absorption amount of carbon dioxide by the absorption source in a future predetermined period for each type of tree, for example, in the case of trees from the information to be used for selecting the calculation expression for calculating the absorption amount described above using the selected calculation expression. The absorption amount estimation unit 1253 further estimates the total absorption amount of carbon dioxide by the absorption source in a future predetermined period. The future predetermined period is, for example, a period of a predetermined length starting from the present. The future predetermined period may be, for example, a period of a predetermined length starting from a certain time point in the future. For a plurality of future predetermined periods including a period of a predetermined length starting from the present and a period of a predetermined length starting from one or more future time points, for example, in the case of trees, the absorption amount estimation unit 1253 may estimate at least one of the absorption amount of carbon dioxide by the absorption source for each type of trees and the total absorption amount of carbon dioxide by the absorption source.

The absorption amount estimation unit 1253 stores the estimated absorption amount of carbon dioxide (for example, the absorption amount of carbon dioxide for each type of trees by the absorption source in a future predetermined period, the absorption amount of carbon dioxide by an artificial substance, and the total absorption amount of carbon dioxide by the absorption source in a future predetermined period) in the absorption source information storage unit 123.

### Document Creation Unit 130

The document creation unit 130 creates a carbon credit description using the information stored in the absorption source information storage unit 123. The document creation unit 130 may create a carbon credit description from the information stored in the absorption source information storage unit 123 using, for example, a creation model trained by machine learning to create a carbon credit description with the absorption source information as an input. For example, the document creation unit 130 may embed at least part of the information stored in the absorption source information storage unit 123 in a template of a carbon credit description. The document creation unit 130 may display the description generated by embedding at least part of the information stored in the absorption source information storage unit 123 in the template on the display device of the management system 100. The document creation unit 130 may change the description in accordance with an instruction to edit the description input by the operator of the management system 100 using the input device of the management system 100. The document creation unit 130 may pass the information stored in the absorption source information storage unit 123 to an editing program that operates in the management system 100 or another information processing device capable of communicating with the management system 100. At this time, the document creation unit 130 may pass the information stored in the absorption source information storage unit 123 and the data of the template of the description to be used for creating the description to the information processing device. The document creation unit 130 may pass the data of the description generated by embedding at least part of the information stored in the absorption source information storage unit 123 in the template to the information processing device. The document creation unit 130 may receive the data of the description edited by the operator of the information processing device in which the editing program operates from the information processing device. The document creation unit 130 may hold in advance the information about the template of the description of the carbon credit.

Document creation unit 130 transmits the generated or received carbon credit description information to the document presentation unit 131.

### Document Presentation Unit 131

The document presentation unit 131 presents the information about the description of the carbon credit received from the document creation unit 130 to the applicant. Specifically, the document presentation unit 131 transmits the information about the description of the carbon credit to the applicant terminal 200, and causes the applicant terminal 200 to display the information about the description of the carbon credit. The document presentation unit 131 may transmit a message prompting confirmation of information about the description of the carbon credit to the applicant terminal 200. When receiving the request for the description of the carbon credit transmitted from the applicant terminal 200 according to the instruction of the applicant, the document presentation unit 131 may transmit information about the description of the carbon credit to the applicant terminal 200.

The document presentation unit 131 receives, from the applicant terminal 200, information indicating whether a carbon credit description is acceptable (hereinafter, also referred to as description confirmation information) input by the applicant. The document presentation unit 131 transmits the received information (that is, the description confirmation information) indicating whether the description of the carbon credit is acceptable to the document creation unit 130. In a case where the description confirmation information indicates that the description of the carbon credit is not acceptable, that is, indicates that the description of the carbon credit is required to be corrected, the document creation unit 130 notifies the operator of the management system 100 that the description of the carbon credit is required to be corrected. In a case where the operator of the management system 100 is notified that it is necessary to correct the description of the carbon credit, the operator performs an operation of correcting the description according to information obtained from the applicant through an interview or the like. For example, the document creation unit 130 corrects the description of the carbon credit according to a correction instruction input by the operator of the management system 100 using the input device of the management system 100. In a case where the description confirmation information indicates that it is necessary to correct the description of the carbon credit, the description confirmation information may include information indicating a correction content input by the applicant using the input device of the applicant terminal 200. The document creation unit 130 may display the information indicating the correction content on the display device of the management system 100 and receive the correction instruction input by the operator of the management system 100 using the input device of the management system 100. In this case, for example, the document creation unit 130 changes the description of the carbon credit according to the received correction instruction. In a case where new information about the absorption source is necessary for correction of the description, the request information presentation unit 121 may perform presentation for prompting input of necessary information about the absorption source according to an instruction of an operator of the management system 100. In this case, the absorption source information reception unit 122 receives new information about the absorption source from the applicant terminal 200. The document creation unit 130 corrects the description of the carbon credit according to an instruction of an operator of the management system 100 using at least any one of the information received by the absorption source information reception unit 122 and the information generated by the information generation unit 125 from the information received by the absorption source information reception unit 122. In a case where the description of the carbon credit is changed, the document creation unit 130 transmits information about the changed description of the carbon credit to the document presentation unit 131. The document presentation unit 131 presents the information about the received carbon credit description to the applicant.

In a case where the description confirmation information indicates that the description of the carbon credit is acceptable, that is, indicates that it is not necessary to correct the description of the carbon credit, the document creation unit 130 transmits information about the description of the carbon credit to the verification application unit 140.

### Verification Application Unit 140

Upon receiving the information about the description of the carbon credit from the document creation unit 130, the verification application unit 140 transmits the information about the description of the carbon credit and a request for verification of the description of the carbon credit to the verification device 400. The verification application unit 140 may transmit the information about the description of the carbon credit and a request for verification of the description of the carbon credit to the verification device 400 according to an instruction from an operator of the management system 100.

Verification of the carbon credit description is a verification of the format of the carbon credit description. The verification of the format is, for example, a verification that the format of the carbon credit description satisfies a predetermined standard, and a verification that necessary matters are described in the carbon credit description. Format verification is not limited to these verifications. The format verification may not include at least any one of these verifications.

The verification application unit 140 receives information indicating a verification result from the verification device 400. The verification application unit 140 transmits the received information indicating the verification result to the verification result presentation unit 141.

In a case where the received verification result is a failure, the verification application unit 140 transmits information indicating that the verification result is a failure to the document creation unit 130. For example, the document creation unit 130 changes or regenerates the description of the carbon credit according to an instruction of an operator of the management system 100 input using an input device of the management system 100. In this case, the document presentation unit 131 similarly presents a changed or regenerated description (that is, the new carbon credit description) of the carbon credit to the applicant. In a case where the description confirmation information received by the document presentation unit 131 indicates that the description of the carbon credit is acceptable, information about the description of the new carbon credit and a request for verification of the description of the carbon credit are transmitted to the verification device 400.

In a case where the verification result is a pass, the verification application unit 140 transmits information about a description of a carbon credit whose the verification result is a pass to the authentication application unit 150. In this case, the verification application unit 140 may transmit, to the authentication application unit 150, information about a description of a carbon credit whose verification result is a pass and information indicating that the verification result is a pass.

### Verification Result Presentation Unit 141

The verification result presentation unit 141 presents information indicating the received verification result to the applicant. Specifically, the verification result presentation unit 141 may transmit information indicating the received verification result to the applicant terminal 200 and cause the applicant terminal 200 to display the verification result. In a case of receiving the verification result, the verification result presentation unit 141 may transmit information indicating that the verification result has been received to the applicant terminal 200. The verification result presentation unit 141 may transmit information indicating the verification result to the applicant terminal 200 in a case of receiving a request for the verification result from the applicant terminal 200.

### Authentication Application Unit 150

The authentication application unit 150 receives, from the verification application unit 140, information about a description of a carbon credit whose verification result is a pass. The authentication application unit 150 may receive, from the verification application unit 140, information about a description of a carbon credit whose verification result is a pass and information indicating that the verification result is a pass.

When receiving the information about the description of the carbon credit whose verification result is a pass from the verification application unit 140, the authentication application unit 150 transmits the received information about the description of the carbon credit and a request for authentication of the description of the carbon credit to the authentication device 500. The authentication application unit 150 may send, to the authentication device 500, information about a carbon credit description whose verification result is a pass, information indicating that the verification result is a pass, and a request for authentication of the carbon credit description.

The authentication application unit 150 receives information indicating a result of the authentication from the authentication device 500. The authentication application unit 150 transmits the received information indicating the result of the authentication to the authentication result presentation unit 151. The authentication application unit 150 notifies the operator of the management system 100 of the received information indicating the result of the authentication. The authentication application unit 150 may display the received information indicating the result of the authentication on, for example, a display device of the management system 100.

In a case where the result of the authentication is a pass, the authentication application unit 150 transmits information about a description of the carbon credit that has passed the authentication to the issuance application unit 160. The authentication application unit 150 may send, to the issuance application unit 160, information about the description of the carbon credit that has passed the authentication and information indicating that the description of the carbon credit has passed the authentication.

### Authentication Result Presentation Unit 151

The authentication result presentation unit 151 presents information indicating the received authentication result to the applicant. Specifically, the authentication result presentation unit 151 may transmit information indicating the received authentication result to the applicant terminal 200 and cause the applicant terminal 200 to display the authentication result. In a case of receiving the information indicating the result of the authentication, the authentication result presentation unit 151 may transmit the information indicating that the result of the authentication has been received to the applicant terminal 200. The authentication result presentation unit 151 may transmit information indicating the result of the authentication to the applicant terminal 200 in a case of receiving a request for the result of the authentication from the applicant terminal 200.

### Issuance Application Unit 160

The issuance application unit 160 receives, from the authentication application unit 150, information about the description of the carbon credit that has passed the authentication. Upon receiving the information about the description of the carbon credit that has passed the authentication, the issuance application unit 160 applies to an information processing device of a carbon credit issuance organization for issuance of a carbon credit described by the description of the carbon credit that has passed the authentication. The issuance application unit 160 may apply for issuance of a carbon credit described by a description of a carbon credit that has passed the authentication according to an instruction input by an operator of the management system 100 using an input device of the management system 100. In the present example embodiment, the issuance organization of the carbon credit is identical to the verification organization of the carbon credit. In the present example embodiment, the information processing device of the issuance organization of the carbon credit is the verification device 400. The issuance organization of the carbon credit may be different from the verification organization of the carbon credit. The information processing device of the issuance organization of the carbon credit may be different from the verification device 400.

The issuance application unit 160 receives information about the carbon credit issued in response to the request from an information processing device (for example, the verification device 400) of the issuance organization.

### Transaction Mediation Unit 170

The transaction mediation unit 170 performs matching between the issued carbon credit and a carbon credit purchase desiring person. Specifically, the transaction mediation unit 170 receives, from an information processing device (for example, the purchaser terminal 700) of a carbon credit purchase desiring person, information indicating a condition of the carbon credit the purchase of which is desired. The transaction mediation unit 170 extracts a carbon credit matching the condition indicated by the received information. The transaction mediation unit 170 transmits extracted information about the carbon credit to the information processing device (for example, the purchaser terminal 700) of the purchase desiring person. In a case of receiving an offer to purchase the carbon credit from the information processing device of the purchase desiring person, the transaction mediation unit 170 performs the settlement and changes the owner of the carbon credit whose purchase is offered.

### Information Management Unit 180

The information management unit 180 performs a process of amortizing the issued carbon credit. Specifically, the information management unit 180 performs a process of invalidating the carbon credit that has reached the expiration date according to a predetermined invalidation process method. In a case where there is a plurality of carbon credits having the same absorption source, the information management unit 180 identifies a valid carbon credit from the plurality of carbon credits. The information management unit 180 performs a process of invalidating a carbon credit that has not been identified as a valid carbon credit among the plurality of carbon credits. The information management unit 180 determines a carbon credit has undergone proper authentication among a plurality of carbon credits having the same absorption source, for example, according to a predetermined determination method. The information management unit 180 performs a process of invalidating a carbon credit that has not been determined to be a carbon credit has undergone proper authentication.

In a case where there is a plurality of carbon credits that has undergone proper authentication among a plurality of carbon credits having the same absorption source, the information management unit 180 selects one valid carbon credit according to a predetermined method. For example, the information management unit 180 may select a carbon credit that has passed the authentication earliest and that has undergone proper authentication. The information management unit 180 performs a process of invalidating carbon credits other than the selected carbon credit among a plurality of carbon credits having the same absorption source.

### Operation

Next, an operation of the management system according to the second example embodiment of the present disclosure will be described in detail with reference to the drawings.

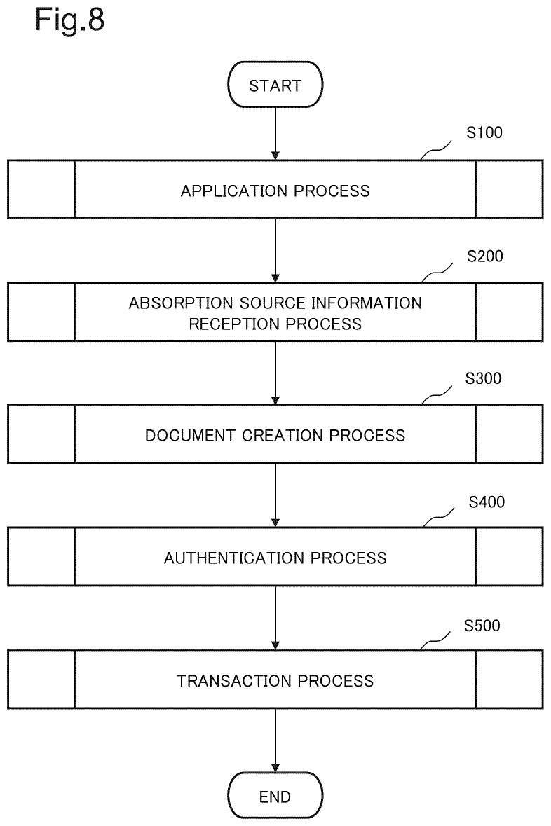

FIG. 8 is a flowchart illustrating an example of the entire operation of the management system according to the second example embodiment of the present disclosure. In the example illustrated in FIG. 8, the management system 100 first performs an application process (step S100). Next, the management system 100 performs an absorption source information reception process (step S200). Next, the management system 100 performs a document creation process (step S300). The management system 100 performs an authentication process (step S400). The management system 100 performs a transaction process (step S500).

The application process, the absorption source information reception process, the document creation process, the authentication process, and the transaction process will be described in detail below. The management system 100 may perform the application process, the absorption source information reception process, the document creation process, and the authentication process for a new carbon credit for a new carbon credit, and the transaction process for an already issued carbon credit in parallel.

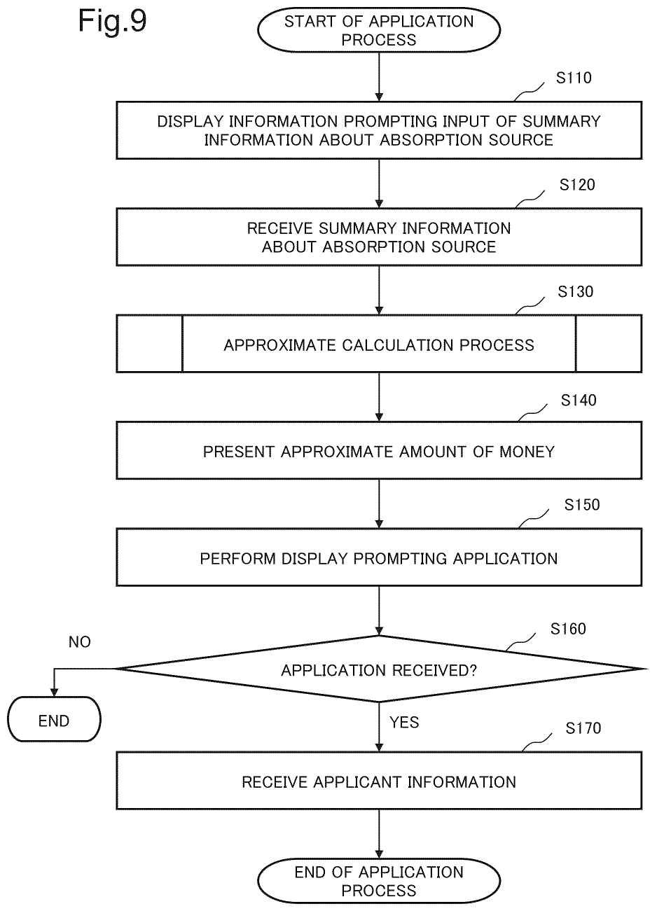

FIG. 9 is a flowchart illustrating an example of the operation of the application process of the management system according to the second example embodiment of the present disclosure. In the example illustrated in FIG. 9, first, the summary information reception unit 111 displays information prompting input of the summary information about the absorption source (step S110). The information prompting the input of the summary information may be information about a user interface for inputting the summary information. Next, the summary information reception unit 111 receives the summary information about the absorption source (step S120). The approximate calculation unit 112 performs an approximate calculation process of calculating an approximate amount of money of the carbon credit of the absorption source (step S130). The approximate calculation process will be described in detail later. Next, the approximate amount-of-money presentation unit 113 presents the approximate amount (step S140). For example, in addition to the presentation of the approximate amount, the approximate amount-of-money presentation unit 113 performs display for prompting application for creation of a carbon credit of an absorption source (step S150). In step S150, the approximate amount-of-money presentation unit 113 may display a menu from which it is possible to select to calculate the approximate amount again. In a case where it is selected to calculate the approximate amount again by operating the menu, the management system 100 may perform the operations in and after step S110 again. At this time, in a case where information of a different absorption source is input in step S120, the approximate calculation unit 112 calculates an approximate amount of money of a carbon credit of the different absorption source in step S130. In step S140, the approximate amount-of-money presentation unit 113 presents an approximate amount of money of a carbon credit of the different absorption source.

In a case where the application reception unit 114 receives the application for creation of the carbon credit of the absorption source (YES in step S160), the application reception unit 114 receives the applicant information that is information about the applicant (step S170). In a case where the application reception unit 114 does not receive the application for creation of the carbon credit of the absorption source (NO in step S160), the management system 100 terminates the operation.

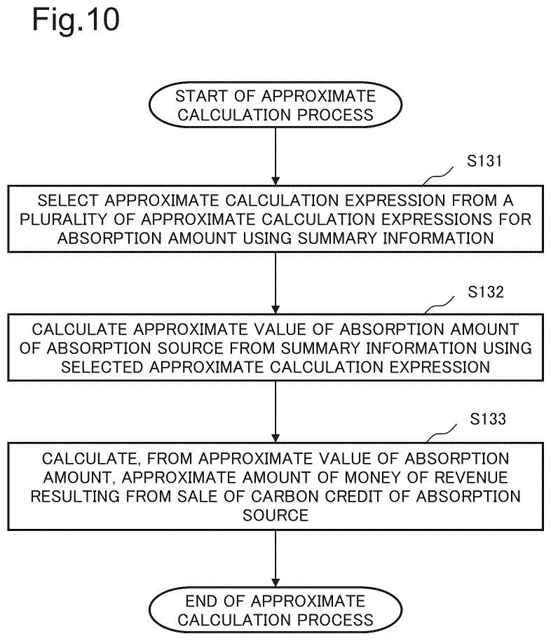

FIG. 10 is a flowchart illustrating an example of the operation of an approximate calculation process of the management system according to the second example embodiment of the present disclosure. In the example illustrated in FIG. 10, the approximate calculation expression selection unit 1121 selects an approximate calculation expression from a plurality of approximate calculation expressions of the absorption amount of carbon dioxide using the summary information about the absorption source (step S131). In step S131, the approximate calculation expression selection unit 1121 selects one approximate calculation expression. Next, the absorption amount approximate calculation unit 1122 calculates an approximate value of the absorption amount of the absorption source from the summary information using the selected approximate calculation expression (step S132). Next, the amount-of-money approximate calculation unit 1123 calculates, from the calculated approximate value of the absorption amount, an approximate amount of money of revenue resulting from the sale of a carbon credit of the absorption source (step S133).

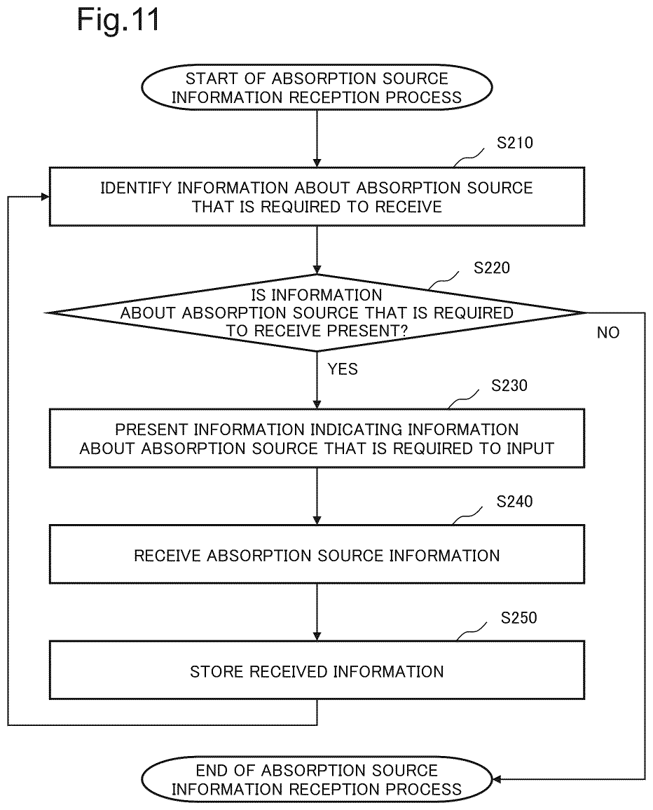

FIG. 11 is a flowchart illustrating an example of the operation of an absorption source information reception process of the management system according to the second example embodiment of the present disclosure. In the example illustrated in FIG. 11, the necessary information identification unit 124 identifies information about an absorption source that is required to receive (step S210). The information that is required to receive is information that has not been received among information necessary for creating a carbon credit of the absorption source. In a case where there is no information about the absorption source that is required to receive (NO in step S220), the management system 100 ends the operation illustrated in FIG. 11.

In a case where there is information about an absorption source that is required to receive (YES in step S220), the request information presentation unit 121 presents information about an absorption source that is required to receive, that is, information indicating information about an absorption source that is required to be input by the applicant (step S230). The absorption source information reception unit 122 receives the input absorption source information (step S240). The absorption source information reception unit 122 stores the received information (step S250). In step S250, the absorption source information reception unit 122 stores the received information in the absorption source information storage unit 123. Next, the management system 100 repeats the operations in and after step S210.

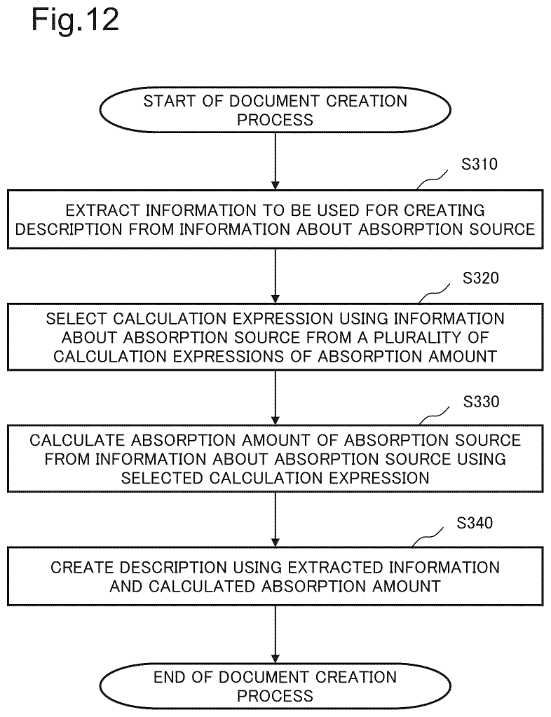

FIG. 12 is a flowchart illustrating an example of the operation of a document creation process of the management system according to the second example embodiment of the present disclosure. In the example illustrated in FIG. 12, first, the information extraction unit 1251 extracts information to be used for creating a description of a carbon credit from information about the absorption source (step S310). Next, the calculation expression selection unit 1252 selects a calculation expression using the information about the absorption source from a plurality of calculation expressions of the absorption amount (step S320). Next, the absorption amount estimation unit 1253 calculates the absorption amount of the absorption source from the information about the absorption source using the selected calculation expression (step S330). The absorption amount of the absorption source is the above-described absorption amount of carbon dioxide by the absorption source in a future predetermined period. Next, the document creation unit 130 generates a description using the extracted information and the calculated absorption amount, for example, according to an instruction of an operator of the management system 100 (step S340).

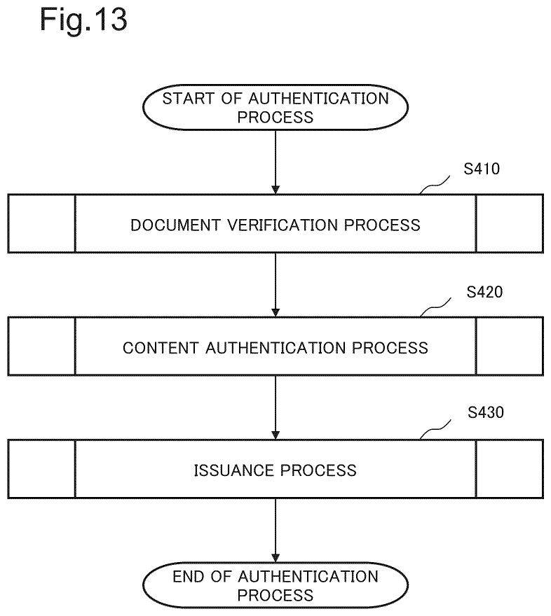

FIG. 13 is a flowchart illustrating an example of the operation of an authentication process of the management system according to the second example embodiment of the present disclosure. In the example illustrated in FIG. 13, the management system 100 of the present example embodiment first performs a document verification process (step S410).

Next, the management system 100 performs a content authentication process (step S420). The management system 100 performs an issuance process (step S430). The document verification process, the content authentication process, and the issuance process will be described in detail later.

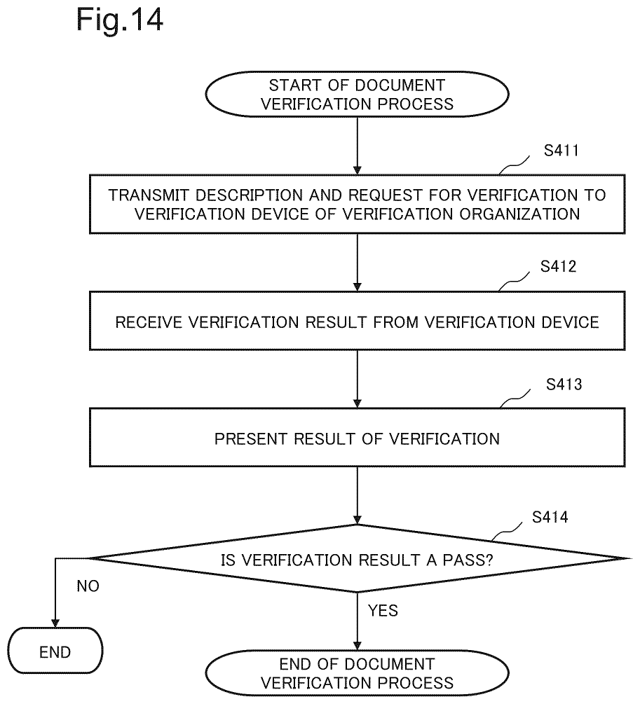

FIG. 14 is a flowchart illustrating an example of the operation of a document verification process of the management system according to the second example embodiment of the present disclosure. In the example illustrated in FIG. 14, first, the verification application unit 140 transmits a description of a carbon credit and a verification request to the verification device 400 of the verification organization (step S411). The verification application unit 140 receives the verification result from the verification device 400 (step S412). The verification result presentation unit 141 presents the verification result (step S413). In a case where the verification result is not a pass (NO in step S414), in the example of FIG. 14, the management system 100 ends the entire operation. In this case, the management system 100 may repeat the operation from the document creation process in step S300 in FIG. 8. At this time, the document creation unit 130 corrects or regenerates the description according to an instruction from an operator of the management system 100. In a case where the result of the verification is a pass (YES in step S414), the management system 100 ends the operation illustrated in FIG. 14.

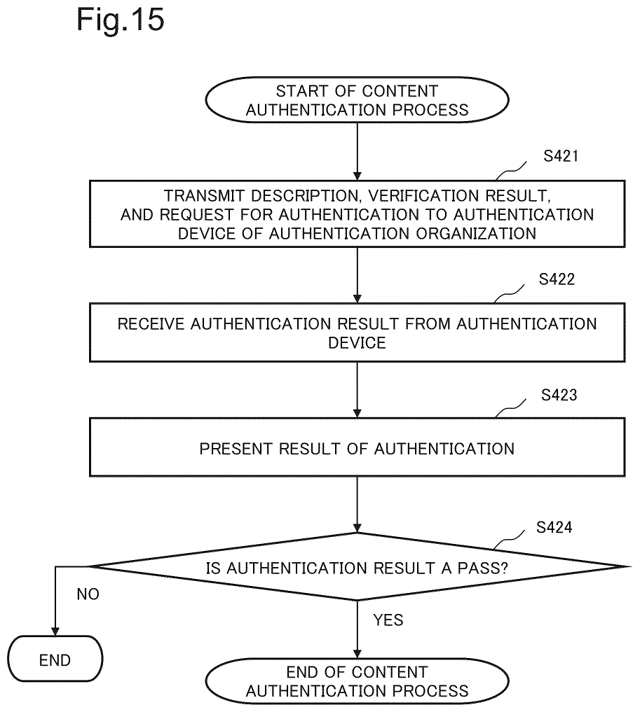

FIG. 15 is a flowchart illustrating an example of the operation of a content authentication process of the management system according to the second example embodiment of the present disclosure. In the example illustrated in FIG. 15, the authentication application unit 150 transmits a carbon credit description, a verification result, and an authentication request to the authentication device 500 of the authentication organization (step S421). The authentication application unit 150 receives an authentication result from the authentication device 500 (step S422).

Next, authentication result presentation unit 151 presents a result of the authentication (step S423). In a case where the result of the authentication is not a pass (NO in step S424), the management system 100 ends the entire operation. In this case, the management system 100 may repeat the operation from the document creation process in step S300 in FIG. 8. In a case where the result of the authentication is a pass (YES in step S424), the management system 100 ends the operation illustrated in FIG. 15.

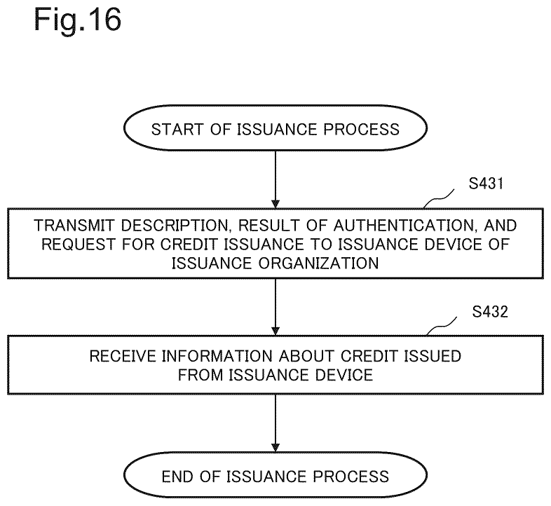

FIG. 16 is a flowchart illustrating an example of the operation of an issuance process of the management system according to the second example embodiment of the present disclosure. In the example illustrated in FIG. 16, the issuance application unit 160 transmits a description of a carbon credit, a result of authentication, and a request for issuance of a credit to an issuance device of an issuance organization.

In the present example embodiment, the issuance period is an organization same as the verification organization, and the issuance device is an information processing device of the verification organization and is the verification device 400. The issuance application unit 160 receives information about the issued credit (that is, carbon credit) from the issuance device (step S432).

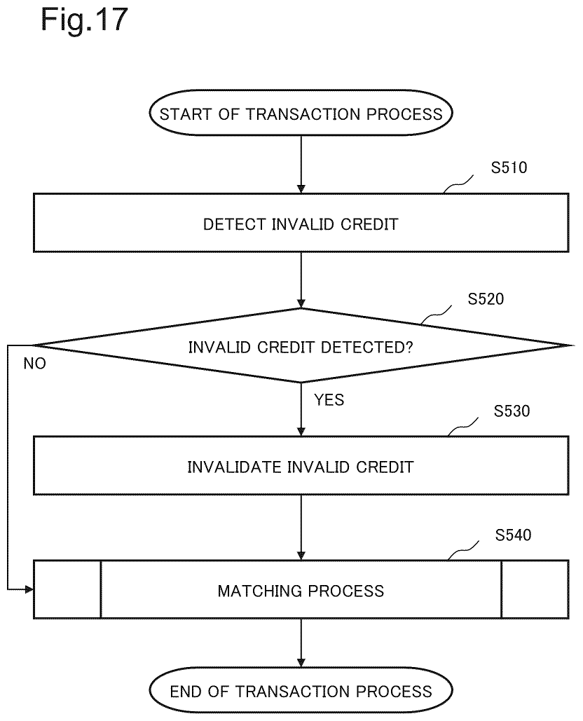

FIG. 17 is a flowchart illustrating an example of an operation of a transaction process of the management system according to the second example embodiment of the present disclosure. In the example illustrated in FIG. 17, the information management unit 180 detects an invalid credit (step S510). In FIG. 17, the credit is a carbon credit. In a case where an invalid credit is not detected (NO in step S520), the management system 100 next performs the operation in step S540.

In a case where an invalid credit is detected (YES in step S520), the information management unit 180 invalidates the invalid credit (step S530).

In step S540, the management system 100 performs a matching process (step S540). The matching process will be described in detail later. The management system 100 ends the operation illustrated in FIG. 17. The management system 100 may repeatedly perform the operation illustrated in FIG. 17 in parallel with the operations from step S100 to step S400 in FIG. 8.

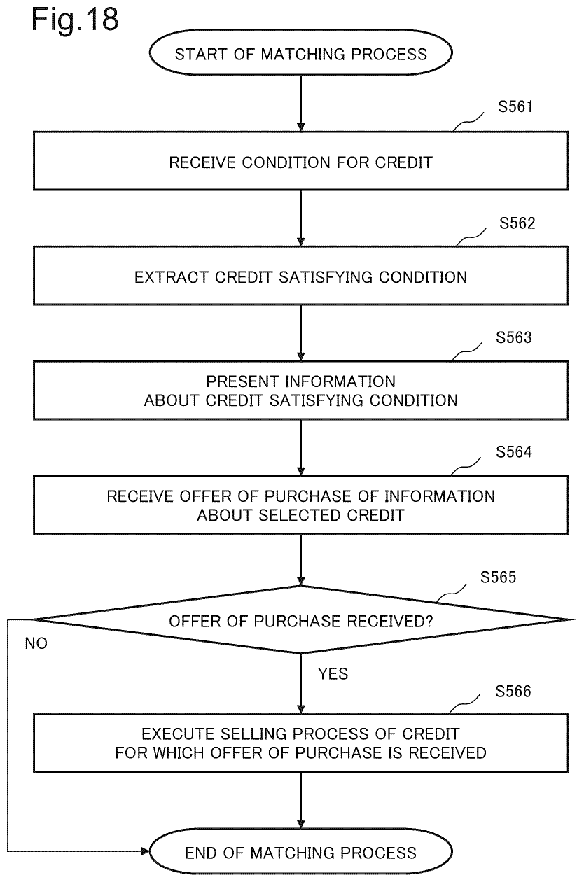

FIG. 18 is a flowchart illustrating an example of the operation of a matching process of the management system according to the second example embodiment of the present disclosure. In the example illustrated in FIG. 18, the transaction mediation unit 170 receives the condition for the credit from, for example, the purchaser terminal 700 (step S561). The transaction mediation unit 170 extracts a credit satisfying the received condition (step S562). The transaction mediation unit 170 presents information about the extracted credit, that is, information about the credit satisfying the condition, to the purchaser terminal 700 that has transmitted the condition (step S563). The transaction mediation unit 170 receives an offer to purchase the selected credit from the purchaser terminal 700 (step S564). In a case where the offer of purchase has not been received (NO in step S565), the management system 100 ends the operation illustrated in FIG. 18.

In a case where the offer of purchase has been received (YES in step S565), the transaction mediation unit 170 executes a selling process of the credit for which the offer of purchase has been received (step S566). The selling process is, for example, the process of settlement associated with the sale and the process of changing the name of the credit to be sold to the name of the purchaser.

### Effects

The present example embodiment has the effect same as that of the first example embodiment. The reason is identical to the reason why the effect of the first example embodiment occurs.

### First Modification of Second Example Embodiment

The management system 100 may not include at least any one of the transaction mediation unit 170 and the information management unit 180. In a case where the management system 100 does not include the information management unit 180, the management system 100 does not perform a process of amortizing the issued carbon credit. In a case where the management system 100 does not include the transaction mediation unit 170, the management system 100 does not mediate the transaction of the issued carbon credit. In a case where the management system 100 includes the information management unit 180 but does not include the transaction mediation unit 170, the information management unit 180 receives information about the issued carbon credit from, for example, the issuance application unit 160.

### Second Modification of Second Example Embodiment

The application for authentication of the project description may be performed by a verification organization. In this case, the authentication application unit 150 does not apply for authentication of the description of the project. In a case where the result of the verification of the project description is a pass, the verification organization may apply for the verification organization to authenticate the project description without receiving an instruction of authentication from the management system 100. In this case, the authentication application unit 150 may not transmit the instruction to authenticate the description of the project. In a case where the result of the verification of the project description is a pass, the verification organization may apply for the verification organization to authenticate the project description upon receiving an instruction of authentication from the management system 100. In this case, in a case where the verification result of the project description received from the verification organization is a pass, the authentication application unit 150 transmits an instruction to authenticate the project description to the verification organization.

In these cases, the authentication application unit 150 receives a result of authentication of the description of the project from the verification organization.

### Third Modification of Second Example Embodiment

Carbon credit information may be implemented using existing blockchain technology.

In this case, the document creation unit 130 registers the hash information of the information about the description of the project in the blockchain.

The verification application unit 140 verifies that the project information to be applied for is not tampered using the previous hash information, and performs internal verification. The verification application unit 140 also registers a hash of the verification result in the blockchain.

The authentication application unit 150 verifies that the data is not tampered using the hash of the preceding project information and the hash of the verification result, and performs an authentication process. The authentication application unit 150 also registers a hash of the authentication result in the blockchain.

The issuance application unit 160 verifies that the data is not tampered using the hash of the project information in the previous stage, the hash of the verification result, and the hash of the authentication result, and performs the application process.

The transaction mediation unit 170 adds a new block including information indicating the transaction to the blockchain of the carbon credit for which the sales contract is established. The information indicating the transaction may be appropriately determined.

The information management unit 180 issues a new transaction including information indicating that the carbon credit is invalid to the blockchain of the carbon credit that has reached the expiration date. The information management unit 180 verifies the validity of the data using the hash registered in the blockchain. In a case where the hashes do not match, the information management unit 180 determines that the data is illegal.

In the present modification, for example, the management system 100, the verification device 400, and the authentication device 500 operate as nodes that store blockchain data. The applicant terminal 200 and the purchaser terminal may also operate as nodes that store blockchain data.

### Other Example Embodiments

The management system according to the example embodiment of the present disclosure can be achieved by a computer including a memory in which a program read from a storage medium is loaded and a processor that executes the program. The management system according to the example embodiment of the present disclosure can be achieved by dedicated hardware. The management system according to the example embodiment of the present disclosure can be achieved by a combination of the above-described computer and dedicated hardware.

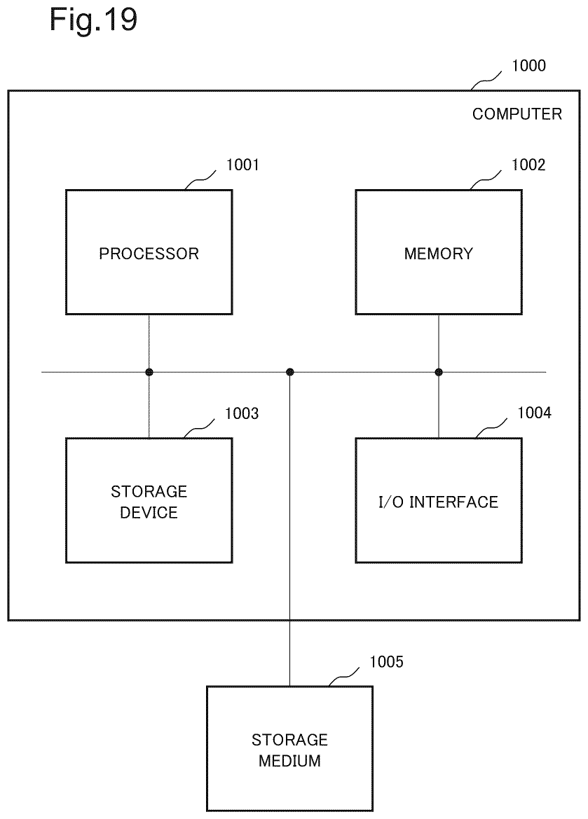

FIG. 19 is a diagram illustrating an example of a hardware configuration of a computer 1000 that can implement the management system according to the example embodiment of the present disclosure.

In the example illustrated in FIG. 19, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and to the memory 1002 and the storage device 1003. The processor 1001 can access, for example, another information processing device or the like connected to the communication network 300 via the I/O interface 1004. The processor 1001 may access the storage medium 1005. The storage medium 1005 stores a program for operating the computer 1000 as the management system according to the example embodiment of the present disclosure.

The processor 1001 loads a program, which is stored in the storage medium 1005 and causes the computer 1000 to operate as the management system according to the example embodiment of the present disclosure, into the memory 1002. The processor 1001 executes the program loaded in the memory 1002, whereby the computer 1000 operates as the management system according to the example embodiment of the present disclosure.

The application processing unit 110, the absorption source information processing unit 120, the document creation unit 130, the document presentation unit 131, the verification application unit 140, the verification result presentation unit 141, the authentication application unit 150, the authentication result presentation unit 151, the issuance application unit 160, the transaction mediation unit 170, and the information management unit 180 can be implemented by, for example, the processor 1001 that executes a program loaded in the memory 1002.

The summary information reception unit 111, the approximate calculation unit 112, the approximate amount-of-money presentation unit 113, the application reception unit 114, the request information presentation unit 121, the absorption source information reception unit 122, the necessary information identification unit 124, and the information generation unit 125 can be implemented by, for example, the processor 1001 that executes a program loaded in the memory 1002. The approximate calculation expression selection unit 1121, the absorption amount approximate calculation unit 1122, the amount-of-money approximate calculation unit 1123, the information extraction unit 1251, the calculation expression selection unit 1252, and the absorption amount estimation unit 1253 can be implemented by, for example, the processor 1001 that executes a program loaded in the memory 1002.

The absorption source information storage unit 123 can be implemented by the memory 1002 included in the computer 1000 or the storage device 1003 such as a hard disk device.

Some or all of the application processing unit 110, the absorption source information processing unit 120, the document creation unit 130, the document presentation unit 131, the verification application unit 140, the verification result presentation unit 141, the authentication application unit 150, the authentication result presentation unit 151, the issuance application unit 160, the transaction mediation unit 170, and the information management unit 180 can be implemented by a dedicated circuit that implements the functions of the respective units. Some or all of the summary information reception unit 111, the approximate calculation unit 112, the approximate amount-of-money presentation unit 113, the application reception unit 114, the request information presentation unit 121, the absorption source information reception unit 122, the absorption source information storage unit 123, the necessary information identification unit 124, and the information generation unit 125 can be implemented by a dedicated circuit that implements the functions of the respective units. Some or all of the approximate calculation expression selection unit 1121, the absorption amount approximate calculation unit 1122, the amount-of-money approximate calculation unit 1123, the information extraction unit 1251, the calculation expression selection unit 1252, and the absorption amount estimation unit 1253 can be implemented by a dedicated circuit that implements the functions of the respective units.

Some or all of the above example embodiments may be denoted as the following Supplementary Notes, but are not limited to the following.

### Supplementary Note 1

A management system including
a summary information reception means for receiving summary information about an absorption source of carbon dioxide,
an approximate calculation means for calculating, from the summary information, an approximate amount of money of revenue resulting from a sale of a carbon credit of the absorption source, and
an approximate amount-of-money presentation means for presenting the calculated approximate amount of money of revenue.

### Supplementary Note 2

The management system according to Supplementary Note 1 further including
an application reception means for registering a provider of the summary information as an applicant of the carbon credit of the absorption source in a case where an application is received in response to presentation of the approximate amount of money of revenue.

### Supplementary Note 3

The management system according to Supplementary Note 1 or 2, wherein
the approximate calculation means includes
an absorption amount approximate calculation means for estimating an approximate absorption amount of carbon dioxide in a future predetermined period by the absorption source using the summary information, and
an amount-of-money approximate calculation means for calculating the approximate amount of money of revenue using the approximate absorption amount.

### Supplementary Note 4

The management system according to Supplementary Note 3, wherein
the approximate calculation means includes
an approximate calculation expression selection means for selecting, using the summary information, at least one approximate calculation expression for calculating the approximate absorption amount of carbon dioxide by the absorption source from a plurality of approximate calculation expressions for calculating an approximate value of an absorption amount of carbon dioxide, and
the absorption amount approximate calculation means estimates the approximate absorption amount using the selected approximate calculation expression and the summary information.

### Supplementary Note 5

The management system according to Supplementary Note 4, wherein
the plurality of approximate calculation expressions is not identical to a plurality of calculation expressions at least some of which are used to calculate an absorption amount of carbon dioxide included in a project description describing information about a carbon credit.

### Supplementary Note 6

The management system according to Supplementary Note 1 or 2, wherein
the summary information includes at least any of information indicating a group of main vegetation in the absorption source, information indicating whether tree trimming is scheduled in a case where the carbon credit is issued, and information indicating whether tree trimming is regularly performed.

### Supplementary Note 7

A management method including
receiving summary information of an absorption source of carbon dioxide,
calculating, from the summary information, an approximate amount of money of revenue resulting from a sale of a carbon credit of the absorption source, and
presenting the calculated approximate amount of money of revenue.

### Supplementary Note 8

The management method according to Supplementary Note 7 further including
registering a provider of the summary information as an applicant of the carbon credit of the absorption source in a case where an application is received in response to presentation of the approximate amount of money of revenue.

### Supplementary Note 9

The management method according to Supplementary Note 7 or 8 further including
estimating an approximate absorption amount of carbon dioxide in a future predetermined period by the absorption source using the summary information, and
calculating the approximate amount of money of revenue using the approximate absorption amount.

### Supplementary Note 10

The management method according to Supplementary Note 9 further including
selecting, using the summary information, at least one approximate calculation expression for calculating the approximate absorption amount of carbon dioxide by the absorption source from a plurality of approximate calculation expressions for calculating an approximate value of an absorption amount of carbon dioxide, and
estimating the approximate absorption amount using the selected approximate calculation expression and the summary information.

### Supplementary Note 11

The management method according to Supplementary Note 10, wherein
the plurality of approximate calculation expressions is not identical to a plurality of calculation expressions at least some of which are used to calculate an absorption amount of carbon dioxide included in a project description describing information about a carbon credit.

### Supplementary Note 12

The management method according to Supplementary Note 7 or 8, wherein
the summary information includes at least any of information indicating a group of main vegetation in the absorption source, information indicating whether tree trimming is scheduled in a case where the carbon credit is issued, and information indicating whether tree trimming is regularly performed.

### Supplementary Note 13

A program for causing a computer to execute
a summary information reception process of receiving summary information about an absorption source of carbon dioxide,
an approximate calculation process of calculating, from the summary information, an approximate amount of money of revenue resulting from a sale of a carbon credit of the absorption source, and
an approximate amount-of-money presentation process of presenting the calculated approximate amount of money of revenue.

### Supplementary Note 14

The program according to Supplementary Note 13 for causing the computer to further execute
an application reception process of registering a provider of the summary information as an applicant of the carbon credit of the absorption source in a case where an application is received in response to presentation of the approximate amount of money of revenue.

### Supplementary Note 15

The program according to Supplementary Note 13 or 14, wherein
the approximate calculation process includes
an absorption amount approximate calculation process of estimating an approximate absorption amount of carbon dioxide in a future predetermined period by the absorption source using the summary information, and
an amount-of-money approximate calculation process of calculating the approximate amount of money of revenue using the approximate absorption amount.

### Supplementary Note 16

The program according to Supplementary Note 15, wherein
the approximate calculation process includes
an approximate calculation expression selection process of selecting, using the summary information, at least one approximate calculation expression for calculating the approximate absorption amount of carbon dioxide by the absorption source from a plurality of approximate calculation expressions for calculating an approximate value of an absorption amount of carbon dioxide, and
the absorption amount approximate calculation process includes estimating the approximate absorption amount using the selected approximate calculation expression and the summary information.

### Supplementary Note 17

The program according to Supplementary Note 16, wherein the plurality of approximate calculation expressions is not identical to a plurality of calculation expressions at least some of which are used to calculate an absorption amount of carbon dioxide included in a project description describing information about a carbon credit.

### Supplementary Note 18

The program according to Supplementary Note 13 or 14, wherein
the summary information includes at least any of information indicating a group of main vegetation in the absorption source, information indicating whether tree trimming is scheduled in a case where the carbon credit is issued, and information indicating whether tree trimming is regularly performed.

While the present disclosure has been particularly shown and described with reference to example embodiments thereof, the present disclosure is not limited to the above example embodiments. Various modifications that can be understood by those of ordinary skill in the art can be made to the configuration and details of the present disclosure within the scope of the present disclosure.

This application claims priority based on Japanese Patent Application No. 2022-190457 filed on Nov. 29, 2022, the entire disclosure of which is incorporated herein.

### REFERENCE SIGNS LIST

10 management system
100 management system
110 application processing unit
111 summary information reception unit
112 approximate calculation unit
113 approximate amount-of-money presentation unit
114 application reception unit
120 absorption source information processing unit
121 request information presentation unit
122 absorption source information reception unit
123 absorption source information storage unit
124 necessary information identification unit
125 information generation unit
130 document creation unit
131 document presentation unit
140 verification application unit
141 verification result presentation unit
150 authentication application unit
151 authentication result presentation unit
160 issuance application unit
170 transaction mediation unit
180 information management unit
200 applicant terminal
300 communication network
400 verification device
500 authentication device
700 purchaser terminal
1000 computer
1001 processor
1002 memory
1003 storage device
1004 I/O interface
1005 storage medium
1121 approximate calculation expression selection unit
1122 absorption amount approximate calculation unit
1123 amount-of-money approximate calculation unit
1251 information extraction unit
1252 calculation expression selection unit
1253 absorption amount estimation unit

What is claimed is:

1. A management system comprising:
at least one memory storing a set of instructions; and
at least one processor configured to execute the set of instructions to:
receive summary information about an absorption source of carbon dioxide;
calculate, from the summary information, an approximate amount of money of revenue resulting from a sale of a carbon credit of the absorption source; and
present the calculated approximate amount of money of revenue.

2. The management system according to claim 1, wherein
the at least one processor is further configured to execute the instructions to
register a provider of the summary information as an applicant of the carbon credit of the absorption source in a case where an application is received in response to presentation of the approximate amount of money of revenue.

3. The management system according to claim 1, wherein
the at least one processor is further configured to execute the instructions to:
estimate an approximate absorption amount of carbon dioxide in a future predetermined period by the absorption source using the summary information; and
calculate the approximate amount of money of revenue using the approximate absorption amount.

4. The management system according to claim 3, wherein
the at least one processor is further configured to execute the instructions to:
select, using the summary information, at least one approximate calculation expression for calculating the approximate absorption amount of carbon dioxide by the absorption source from a plurality of approximate calculation expressions for calculating an approximate value of an absorption amount of carbon dioxide; and
estimate the approximate absorption amount using the selected approximate calculation expression and the summary information.

5. The management system according to claim 4, wherein
the plurality of approximate calculation expressions is not identical to a plurality of calculation expressions at least part of which is used to calculate the absorption amount of carbon dioxide included in a project description describing information about a carbon credit.

6. The management system according to claim 1, wherein
the summary information includes at least any of information indicating a group of main vegetation in the absorption source, information indicating whether tree trimming is scheduled in a case where the carbon credit is issued, and information indicating whether tree trimming is regularly performed.

7. The management system according to claim 1, wherein
the at least one processor is further configured to execute the instructions to:
receive absorption source information indicating information about the absorption source;
estimate an absorption amount of carbon dioxide in a future predetermined period by the absorption source using the absorption source information; and
create a project description describing information about a carbon credit of the absorption source using the absorption source information and the absorption amount, wherein
the summary information is less than the absorption source information.

8. A management method comprising:
receiving summary information of an absorption source of carbon dioxide;
calculating, from the summary information, an approximate amount of money of revenue resulting from a sale of a carbon credit of the absorption source; and
presenting the calculated approximate amount of money of revenue.

9. The management method according to claim 8, further comprising
registering a provider of the summary information as an applicant of the carbon credit of the absorption source in a case where an application is received in response to presentation of the approximate amount of money of revenue.

10. The management method according to claim 8, further comprising:
estimating an approximate absorption amount of carbon dioxide in a future predetermined period by the absorption source using the summary information; and
calculating the approximate amount of money of revenue using the approximate absorption amount.

11. The management method according to claim 10, further comprising:
selecting, using the summary information, at least one approximate calculation expression for calculating the approximate absorption amount of carbon dioxide by the absorption source from a plurality of approximate calculation expressions for calculating an approximate value of an absorption amount of carbon dioxide; and
estimating the approximate absorption amount using the selected approximate calculation expression and the summary information.

12. The management method according to claim 11, wherein
the plurality of approximate calculation expressions is not identical to a plurality of calculation expressions at least part of which is used to calculate an absorption amount of carbon dioxide included in a project description describing information about a carbon credit.

13. The management method according to claim 8, wherein
the summary information includes at least any of information indicating a group of main vegetation in the absorption source, information indicating whether tree trimming is scheduled in a case where the carbon credit is issued, and information indicating whether tree trimming is regularly performed.

14. The management method according to claim 8, further comprising:
receiving absorption source information indicating information about the absorption source;
estimating an absorption amount of carbon dioxide in a future predetermined period by the absorption source using the absorption source information; and
creating a project description describing information about a carbon credit of the absorption source using the absorption source information and the absorption amount, wherein
the summary information is less than the absorption source information.

15. A non-transitory computer readable storage medium storing a program for causing a computer to execute:
summary information reception processing of receiving summary information about an absorption source of carbon dioxide;
approximate calculation processing of calculating, from the summary information, an approximate amount of money of revenue resulting from a sale of a carbon credit of the absorption source; and
approximate amount-of-money presentation processing of presenting the calculated approximate amount of money of revenue.

16. The non-transitory computer readable storage medium according to claim 15, wherein
the program causes the computer to further execute
application reception processing of registering a provider of the summary information as an applicant of the carbon credit of the absorption source in a case where an application is received in response to presentation of the approximate amount of money of revenue.

17. The non-transitory computer readable storage medium according to claim 15, wherein
the approximate calculation processing comprises:
absorption amount approximate calculation processing of estimating an approximate absorption amount of carbon dioxide in a future predetermined period by the absorption source using the summary information; and
amount-of-money approximate calculation processing of calculating the approximate amount of money of revenue using the approximate absorption amount.

18. The non-transitory computer readable storage medium according to claim 17, wherein
the approximate calculation processing comprises
approximate calculation expression selection processing of selecting, using the summary information, at least one approximate calculation expression for calculating the approximate absorption amount of carbon dioxide by the absorption source from a plurality of approximate calculation expressions for calculating an approximate value of an absorption amount of carbon dioxide, and
the absorption amount approximate calculation processing estimates the approximate absorption amount using the selected approximate calculation expression and the summary information.

19. The non-transitory computer readable storage medium according to claim 18, wherein
the plurality of approximate calculation expressions is not identical to a plurality of calculation expressions at least part of which is used to calculate the absorption amount of carbon dioxide included in a project description describing information about a carbon credit.

20. The non-transitory computer readable storage medium according to claim 15, wherein
the summary information includes at least any of information indicating a group of main vegetation in the absorption source, information indicating whether tree trimming is scheduled in a case where the carbon credit is issued, and information indicating whether tree trimming is regularly performed.
